(19) United States
(12) Patent Application Publication
(10) Pub. No.: US 2024/0374447 A1
(43) Pub. Date: Nov. 14, 2024

(54) BED SYSTEM WITH POWER SAVING MODE

(71) Applicant: Sleep Number Corporation, Minneapolis, MN (US)

(72) Inventors: Sajeev Mayandi, Minneapolis, MN (US); Yevhen Parkhomenko, Kharkiv (UA); Faisal Mushtaq, San Diego, CA (US)

(21) Appl. No.: 18/643,648

(22) Filed: Apr. 23, 2024

Related U.S. Application Data
(60) Provisional application No. 63/464,852, filed on May 8, 2023.

(51) Int. Cl. A61G 7/05

(52) U.S. Cl. CPC A61G 7/05

(57) ABSTRACT

A controller is in communication with the at least one sensor. At least one processor of the processors operates in an active-operation mode, and the controller is configured to: receive, from the at least one sensor, sensor signals generated by the at least one sensor responsive to sensing the physical phenomena at the bed system; detect, based on processing the received sensor signals, a bed-exit event at the bed system; generate, based on the detected bed-exit event, instructions to cause the at least one processor to switch from operating in the active-operation mode to a low-power-saving mode; and execute the instructions to cause the at least one processor to operate in the low-power-saving mode.

### CROSS-REFERENCE TO RELATED APPLICATIONS

This application claims the benefit of U.S. Provisional Application Ser. No. 63/464,852, filed May 8, 2023. The disclosure of the prior application is considered part of the disclosure of this application, and is incorporated in its entirety into this application.

The present document relates to automated techniques for determining when a bed system is unoccupied and switching bed components between an active-operation mode to a low-power-saving mode responsive to determining that the bed system is unoccupied.

### BACKGROUND

In general, a bed is a piece of furniture used as a location to sleep or relax. Many modern beds include a soft mattress on a bed frame. The mattress may include springs, foam material, and/or an air chamber to support the weight of one or more occupants.

### SUMMARY

This document generally describes systems, methods, and techniques for switching bed system components from operating in an active-operation mode to a low-power-saving mode. Sensors at a bed system can collect, for example, pressure signals (e.g., continuously or at predetermined times). A controller of the bed system can process the pressure signals to determine whether a user is presented on the bed system or whether the bed system is unoccupied. If the controller determines that the bed system is unoccupied (e.g., for at least a threshold amount of time), the controller can generate instructions that cause one or more of the components of the bed system to suspend processing operations. The processing operations can include determining health and/or sleep metrics about the user of the bed system and/or adjusting the bed system during a sleep session of the user (e.g., articulating a portion of a bed foundation, activating/deactivating heat or cooling to the bed system). The processing operations can be suspended until the controller determines, based on processing the pressure signals or other sensor signals, that the bed system is occupied by the user.

The processing operations can be suspended by switching the bed system components from operating in the active-operation mode to the low-power-saving mode. In the low-power-saving mode, for example, the bed system components may receive a reduced amount of power (e.g., energy, processing power, available compute resources) from other components (e.g., an energy source, such as a battery) until the bed system components are switched back to the active-operation mode. The controller can continuously remain in the active-operation mode and perform minimal processing to determine whether and when the bed system is occupied. In some implementations, the disclosed technology can apply to various processors of the controller or other bed system components. For example, a first processor can operate like the controller described above and continuously process the sensor signals to determine whether the bed system is occupied. A second processor can be switched between the active-operation mode and the low-power-saving mode based on the determination made by the first processor.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a bed system. The bed system includes at least one sensor configured to sense physical phenomena at the bed system. The system also includes a controller having processors and memory, where the controller is in communication with the at least one sensor, where at least one processor of the processors operates in an active-operation mode, where the controller is configured to: receive, from the at least one sensor, sensor signals generated by the at least one sensor responsive to sensing the physical phenomena at the bed system; detect, based on processing the received sensor signals, a bed-exit event at the bed system; generate, based on the detected bed-exit event, instructions to cause the at least one processor to switch from operating in the active-operation mode to a low-power-saving mode; and execute the instructions to cause the at least one processor to operate in the low-power-saving mode. Other embodiments of this aspect include corresponding computer systems, apparatus, and computer programs recorded on one or more computer storage devices, each configured to perform the actions of the methods.

Implementations may include one or more of the following features. The bed system where the controller is further configured to: continuously receive, from the at least one sensor, the sensor signals; detect, based on processing the received sensor signals, a bed-entrance event at the bed system; and generate, based on the detected bed-entrance event, instructions to cause the at least one processor to switch from operating in the low-power-saving mode to the active-operation mode. The instructions cause the at least one processor to resume operations being performed before the at least one processor was switched to operate in the low-power-saving mode. The controller is further configured to execute the instructions based on determining that a threshold amount of time passed since the bed-exit event was detected. Executing the instructions causes the at least one processor to suspend current operations being executed, by the at least one processor. In the low-power-saving mode, the at least one processor is suspended from performing operations. In the low-power-saving mode, the at least one processor is suspended from processing sensor signals that are generated by the at least one sensor. In the low-power-saving mode, the at least one processor is suspended from transmitting the sensor signals and data generated responsive to processing the sensor signals to components of the bed system. In the low-power-saving mode, the at least one processor operates while using less than a threshold amount of power. In the active-operation mode, the at least one processor performs operations while using more than a threshold amount of power. The operations include processing the received sensor signals to determine health or sleep information about a user of the bed system. The operations include executing at least one machine-learning trained model to determine health or sleep information about a user of the bed system. The at least one sensor is a pressure sensor. Detecting the bed-exit event may include: determining, based on the received sensor signals, a change in pressure detected at the bed system; and determining that the change in pressure satisfies bed-exit criteria. Detecting the bed-exit event may include: determining, based on the received sensor signals, a change in temperature at a microclimate of the bed system; and determining that the change in temperature satisfies bed-exit criteria. Detecting the bed-exit event may include determining that a current sleep session of a user of the bed system has ended. Executing the instructions may include transmitting a notification to the at least one processor instructing the at least one processor to suspend current processing. The controller is further configured to generate and execute instructions at predetermined time intervals that cause the at least one processor to (i) switch from operating in the low-power-saving mode to the active-operation mode, (ii) sync with a remote computing system, and (iii) switch from operating in the active-operation mode back to the low-power-saving mode. The predetermined time intervals are every 30 minutes. The controller is configured to iteratively generate and execute the instructions at the predetermined time intervals until a bed-entrance event is detected at the bed system. The at least one processor is isolated from the other processors of the controller and utilizes local memory. While the at least one processor is operating in the low-power-saving mode, another processor of the processors of the controller is configured to remain in an active-operation mode to continuously receive the sensor signals and detect, based on processing the received sensor signals, a bed-entrance event at the bed system. The controller is a pump of the bed system. and the memory of the controller is configured to store the sensor signals that are generated by the at least one sensor, and the at least one processor is configured to: retrieve the sensor signals from the memory; and determine one or more health or sleep information about a user of the bed system based on processing the retrieved sensor signals. The at least one processor is configured to determine the one or more health or sleep information about the user of the bed system in real-time while operating in the active-operation mode. Another processor in the processors of the controller is configured to retrieve a subset of the sensor signals from the memory and detect, based on processing the retrieved subset of the sensor signals, the bed-exit event at the bed system. The memory is shared by the at least one processor and the another processor. Implementations of the described techniques may include hardware, a method or process, or computer software on a computer-accessible medium.

One general aspect includes a bed system. The system includes at least one sensor configured to sense physical phenomena at the bed system. The system also includes a memory device in communication over at least one network with the at least one sensor and configured to receive and store sensor signals generated by the at least one sensor responsive to the at least one sensor sensing the physical phenomena. The system also includes a first processor in communication over the at least one network with at least the memory device and configured to continuously operate in an active-operation mode and detect bed-presence events at the bed system. The system also includes a second processor in communication over the at least one network with at least the memory device and the first processor, where the second processor is configured to switch between the active-operation mode and a low-power-saving mode and perform operations when operating in the active-operation mode. The first processor is configured to perform operations may include: retrieving, from the memory device, a subset of the sensor signals; detecting, based on processing the subset of the sensor signals, a bed-exit event at the bed system; generating, based on the detected bed-exit event, instructions to cause the second processor to switch from operating in the active-operation mode to the low-power-saving mode; and executing the instructions to cause the second processor to switch from operating in the active-operation mode to the low-power-saving mode. Other embodiments of this aspect include corresponding computer systems, apparatus, and computer programs recorded on one or more computer storage devices, each configured to perform the actions of the methods.

Implementations may include one or more of the following features. The bed system where the second processor is configured to operate in the active-operation mode until the first processor detects the bed-exit event. The first processor is configured to retrieve, from the memory device, the subset of the sensor signals at predetermined time intervals. The predetermined time intervals are every 30 minutes. The first processor is configured to retrieve, from the memory device, the subset of the sensor signals in near real-time, as the sensor signals are generated by the at least one sensor and stored in the memory device. Executing the instructions causes the second processor to suspend performing the operations. The second processor is configured to suspend performing the operations until a bed-entrance event is detected at the bed system by the first processor. The bed system further includes a controller, and the first processor and the second processor are part of the controller. The controller is a pump of the bed system. The memory device is separate from the first processor and the second processor. The first processor is different than the second processor. In the active-operation mode, the second processor is configured to: retrieve, from the memory device, at least some of the sensor signals; and determine at least one health or sleep metric about a user of the bed system based on processing the at least some of the sensor signals. Implementations of the described techniques may include hardware, a method or process, or computer software on a computer-accessible medium.

One general aspect includes a bed system for automatically switching bed components between a low-power operational state and a normal operational state based on processing sensor signals received at the bed system. Other embodiments of this aspect include corresponding computer systems, apparatus, and computer programs recorded on one or more computer storage devices, each configured to perform the actions of the methods.

Implementations may include one or more of the following features. The bed system where the bed components include a processor. The processor is configured to determine, based on the sensor signals and while operating in the normal operational state, at least one of health metrics and sleep metrics about a user of the bed system. In the low-power operational state, the bed components are configured to suspend operations. The bed components are configured to perform operations in the normal operational state while a bed-presence event is detected, based on processing the sensor signals, at the bed system. The bed components are configured to switch to the low-power operational state and suspend operations when a bed-exit event is detected, based on processing the sensor signals, at the bed system until a bed-presence event is detected at the bed system. Implementations of the described techniques may include hardware, a method or process, or computer software on a computer-accessible medium.

One general aspect includes a bed system. The bed system includes at least one sensor configured to sense physical phenomena at the bed system. The system also includes a controller in communication with the at least one sensor, where the controller is configured to: receive, from the at least one sensor, sensor signals generated by the at least one sensor responsive to sensing the physical phenomena at the bed system; determine, based on processing the received sensor signals, bed information at the bed system; determine whether the bed information satisfies power-saving criteria; generate, based on determining that the bed information satisfies power-saving criteria, instructions that cause the controller to switch from operating in an active-operation mode to a low-power-saving mode; and execute the instructions to cause the controller to operate in the low-power-saving mode. Other embodiments of this aspect include corresponding computer systems, apparatus, and computer programs recorded on one or more computer storage devices, each configured to perform the actions of the methods.

Implementations may include one or more of the following features. The bed system where the bed information is a bed-exit event by a user at the bed system. The controller determines that the bed information satisfies the power-saving criteria based on (i) detecting the bed-exit event and (ii) determining that a threshold amount of time passed since detecting the bed-exit event, where during the threshold amount of time, a bed-entrance event is not detected from processing the received sensor signals. The bed information is biometrics of a user at the bed system. The controller determines that the bed information does not satisfy the power-saving criteria based on detecting the biometrics of the user for at least a threshold period of time. At a later time, the controller is configured to: detect the biometrics of the user for at least the threshold period of time; determine that the detected biometrics of the user satisfy power-activation criteria; and generate instructions that cause the controller to switch from operating in the low-power-saving mode to the active-operation mode. The controller may include a first processor and a second processor. The first processor continuously operates in the active-operation mode and the second processor switches to operate between the active-operation mode and the low-power-saving mode. The first processor is configured to perform the receiving, determining, generating, and executing steps. The first processor is configured to generate and execute instructions that cause the second processor to switch from operating in the active-operation mode to the low-power-saving mode. Implementations of the described techniques may include hardware, a method or process, or computer software on a computer-accessible medium.

The devices, system, and techniques described herein may provide one or more of the following advantages. For example, the disclosed technology provides for instant as well as long-term power savings. Carbon footprint reduction is a worldwide trend. Bed systems, such as smart or automated beds, amongst other types of consumer electronic devices, are inactivate for long amounts of time. Sometimes, for example, a smart bed can be inactive (e.g., no user may be resting in the bed) for approximately two-thirds of a day. The disclosed technology provides low-level hardware for use in bed systems to automatically identify when the bed system is inactive and suspend processing of bed system components while inactive. Suspending processing can include limiting amounts of processing power or other power that is provided to the bed system components, thereby reducing overall carbon footprint and resulting in power savings. As an illustrative example, in the normal active-operation mode, a processor can consume 900 mW of power to process sensor signals received from the bed system. When the example processor is switched to the low-power-savings mode using the disclosed technology, the processor can consume 750 mW or less of power. Over time, this processor can consume 150 KW per hour, 876,000 kW per year, and/or approximately 308.35 tones of CO₂ per year. Although these numbers are merely illustrative, they exhibit potential power savings and reduction of carbon footprint that are possible using the disclosed technology.

The bed system components can include processors that utilize significant amounts of power and compute resources to process data and determine real-time or near real-time information about users of the bed system or the bed system itself. The disclosed technology therefore provides for suspending processing of such processors when the bed system is inactive so that the processors can be put in a deep sleep state. A lower-level processor that utilizes less power and/or compute resources can efficiently continue to monitor data (such as pressure data from pressure sensors of the bed system) to detect bed activity (e.g., bed presence) and thus wake up the other processors from the deep sleep state when the bed system is active (e.g., a user is detected in the bed).

As another example, the disclosed technology can be easily implemented into existing bed components and/or overall bed systems. The disclosed technology requires minimal modifications to existing computing systems of the bed, such as a controller. For example, the disclosed technology can leverage existing processors and memory in the controller. A low-level processor may also be added to the controller in order to detect bed presence or other bed activity and therefore determine when the other processors of the controller should be switched between the active-operation mode and the low-power-saving mode.

Since only one low-level, lightweight processor may continuously process data while the bed system is inactive and other processors are in a low-power-saving mode, the disclosed technology provides for more efficient real-time or near real-time identification of bed presence events. Since fewer bed system components are operating when the bed system is inactive, network bandwidth may not be clogged and available compute resources and processing power may be saved rather than spread thin amongst the many bed system components. As a result, processes that are running while the bed system is inactive can be performed efficiently and accurately without much, if any, overhead, lag, or requirement to divvy up available or limited resources.

The details of one or more implementations are set forth in the accompanying drawings and the description below. Other features, aspects and potential advantages will be apparent from the accompanying description and figures.

### DESCRIPTION OF DRAWINGS

FIG. 1 shows an example air bed system.

FIG. 2 is a block diagram of an example of various components of an air bed system.

FIG. 3 shows an example environment including a bed in communication with devices located in and around a home.

FIGS. 4A and 4B are block diagrams of example data processing systems that can be associated with a bed.

FIGS. 5 and 6 are block diagrams of examples of motherboards that can be used in a data processing system associated with a bed.

FIG. 7 is a block diagram of an example of a daughterboard that can be used in a data processing system associated with a bed.

FIG. 8 is a block diagram of an example of a motherboard with no daughterboard that can be used in a data processing system associated with a bed.

FIG. 9A is a block diagram of an example of a sensory array that can be used in a data processing system associated with a bed.

FIG. 9B is a schematic top view of a bed having an example of a sensor strip with one or more sensors that can be used in a data processing system associated with the bed.

FIG. 9C is a schematic diagram of an example bed with force sensors located at the bottom of legs of the bed.

FIG. 10 is a block diagram of an example of a control array that can be used in a data processing system associated with a bed

FIG. 11 is a block diagram of an example of a computing device that can be used in a data processing system associated with a bed.

FIGS. 12-16 are block diagrams of example cloud services that can be used in a data processing system associated with a bed.

FIG. 17 is a block diagram of an example of using a data processing system that can be associated with a bed to automate peripherals around the bed.

FIG. 18 is a schematic diagram that shows an example of a computing device and a mobile computing device.

FIG. 19 is a conceptual diagram for switching bed system components between active-operation mode and low-power-saving mode.

FIGS. 20A-B is a flowchart of a process for switching bed system components between active-operation mode and low-power-saving mode.

FIGS. 21A-B is a flowchart of a process for switching bed system components between active-operation mode and low-power-saving mode.

FIG. 22 is an example system architecture for switching bed system components between active-operation mode and low-power-saving mode.

FIG. 23 is another example system architecture for switching bed system components between active-operation mode and low-power-saving mode.

Like reference symbols in the various drawings indicate like elements.

### DETAILED DESCRIPTION

This document generally describes systems, methods, and techniques for determining when to switch bed system components from operating in active-operation modes and low-power-saving modes and vice-versa. In general, some processors can be put into a low-power-saving mode while another processor analyzes sensor data only to determine bed presence. Then, when the bed presence is detected, the processor that analyzes the sensor data can generate instructions to wake up the processors from the low-power-saving mode and puts those other processors back into the active-operation mode. The bed system components can include processors configured to process and analyze sensor data received from sensors of the bed system (or other data sources) to determine various information about a sleeper and/or the sleeper's bed system. The information can include sleeper health metrics and other sleeper information (e.g., sleep quality, ways to improve the user's sleep experience and/or sleep quality). Implementing the disclosed technology can advantageously lower power consumption of the bed system components, increase efficiency of using available compute resources and processing power, and lead to overall reductions in carbon footprint.

### Example Airbed Hardware

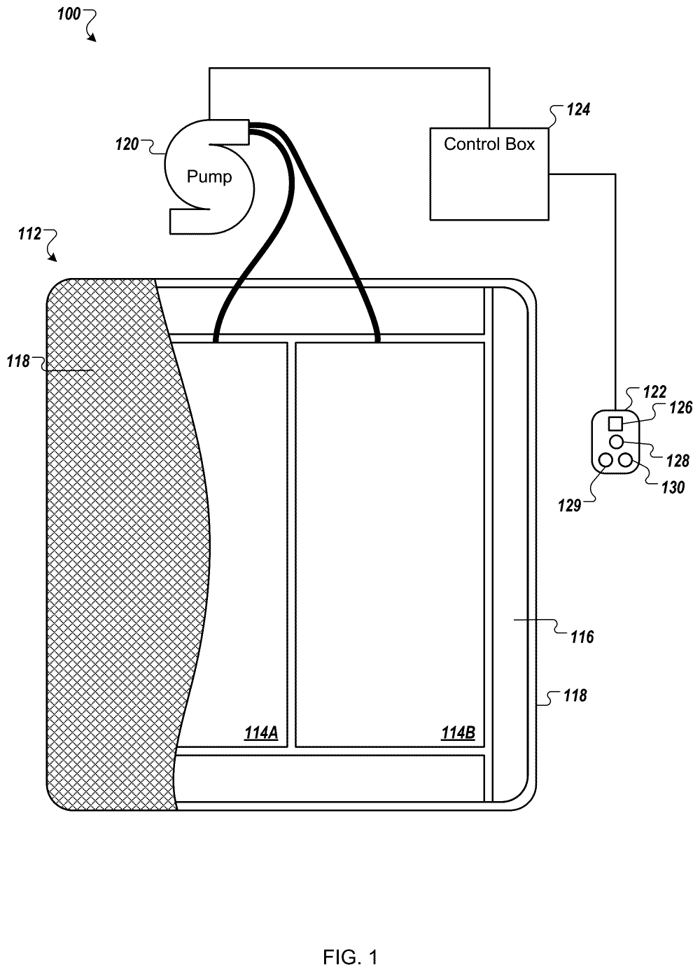

FIG. 1 shows an example air bed system 100 that includes a bed 112. The bed 112 can be a mattress that includes at least one air chamber 114 surrounded by a resilient border 116 and encapsulated by bed ticking 118. The resilient border 116 can comprise any suitable material, such as foam. In some embodiments, the resilient border 116 can combine with a top layer or layers of foam (not shown in FIG. 1) to form an upside down foam tub. In other embodiments, mattress structure can be varied as suitable for the application.

As illustrated in FIG. 1, the bed 112 can be a two chamber design having first and second fluid chambers, such as a first air chamber 114A and a second air chamber 114B. Sometimes, the bed 112 can include chambers for use with fluids other than air that are suitable for the application. For example, the fluids can include liquid. In some embodiments, such as single beds or kids' beds, the bed 112 can include a single air chamber 114A or 114B or multiple air chambers 114A and 114B. Although not depicted, sometimes, the bed 112 can include additional air chambers.

The first and second air chambers 114A and 114B can be in fluid communication with a pump 120. The pump 120 can be in electrical communication with a remote control 122 via control box 124. The control box 124 can include a wired or wireless communications interface for communicating with one or more devices, including the remote control 122. The control box 124 can be configured to operate the pump 120 to cause increases and decreases in the fluid pressure of the first and second air chambers 114A and 114B based upon commands input by a user using the remote control 122. In some implementations, the control box 124 is integrated into a housing of the pump 120. Moreover, sometimes, the pump 120 can be in wireless communication (e.g., via a home network, WIFI, BLUETOOTH, or other wireless network) with a mobile device via the control box 124. The mobile device can include but is not limited to the user's smartphone, cell phone, laptop, tablet, computer, wearable device, home automation device, or other computing device. A mobile application can be presented at the mobile device and provide functionality for the user to control the bed 112 and view information about the bed 112. The user can input commands in the mobile application presented at the mobile device. The inputted commands can be transmitted to the control box 124, which can operate the pump 120 based upon the commands.

The remote control 122 can include a display 126, an output selecting mechanism 128, a pressure increase button 129, and a pressure decrease button 130. The remote control 122 can include one or more additional output selecting mechanisms and/or buttons. The display 126 can present information to the user about settings of the bed 112. For example, the display 126 can present pressure settings of both the first and second air chambers 114A and 114B or one of the first and second air chambers 114A and 114B. Sometimes, the display 126 can be a touch screen, and can receive input from the user indicating one or more commands to control pressure in the first and second air chambers 114A and 114B and/or other settings of the bed 112.

The output selecting mechanism 128 can allow the user to switch air flow generated by the pump 120 between the first and second air chambers 114A and 114B, thus enabling control of multiple air chambers with a single remote control 122 and a single pump 120. For example, the output selecting mechanism 128 can by a physical control (e.g., switch or button) or an input control presented on the display 126. Alternatively, separate remote control units can be provided for each air chamber 114A and 114B and can each include the ability to control multiple air chambers. Pressure increase and decrease buttons 129 and 130 can allow the user to increase or decrease the pressure, respectively, in the air chamber selected with the output selecting mechanism 128. Adjusting the pressure within the selected air chamber can cause a corresponding adjustment to the firmness of the respective air chamber. In some embodiments, the remote control 122 can be omitted or modified as appropriate for an application.

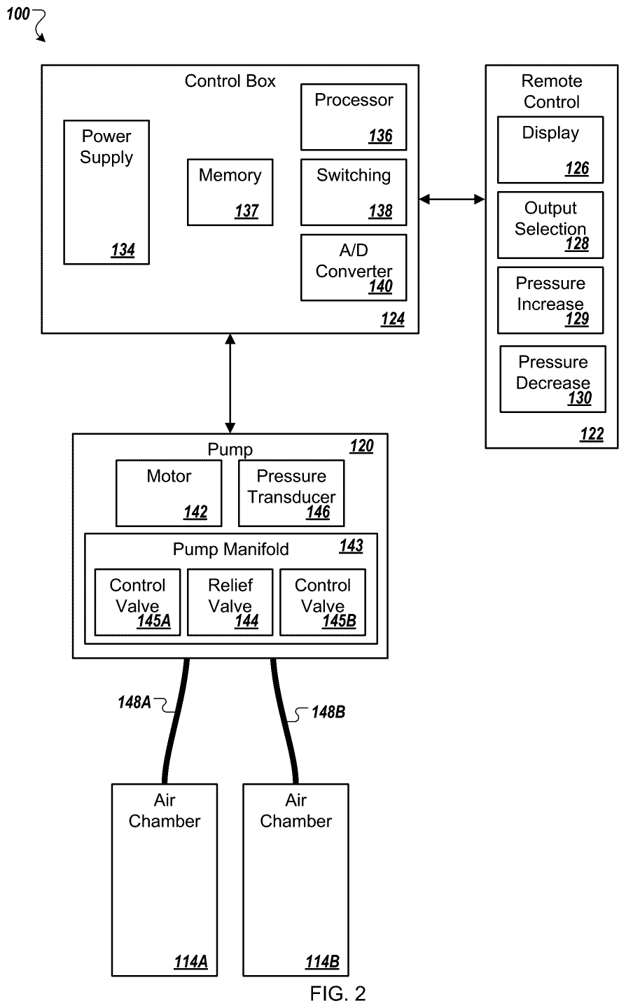

FIG. 2 is a block diagram of an example of various components of an air bed system. These components can be used in the example air bed system 100. The control box 124 can include a power supply 134, a processor 136, a memory 137, a switching mechanism 138, and an analog to digital (A/D) converter 140. The switching mechanism 138 can be, for example, a relay or a solid state switch. In some implementations, the switching mechanism 138 can be located in the pump 120 rather than the control box 124. The pump 120 and the remote control 122 can be in two-way communication with the control box 124. The pump 120 includes a motor 142, a pump manifold 143, a relief valve 144, a first control valve 145A, a second control valve 145B, and a pressure transducer 146. The pump 120 is fluidly connected with the first air chamber 114A and the second air chamber 114B via a first tube 148A and a second tube 148B, respectively. The first and second control valves 145A and 145B can be controlled by switching mechanism 138, and are operable to regulate the flow of fluid between the pump 120 and first and second air chambers 114A and 114B, respectively.

In some implementations, the pump 120 and the control box 124 can be provided and packaged as a single unit. In some implementations, the pump 120 and the control box 124 can be provided as physically separate units. The control box 124, the pump 120, or both can be integrated within or otherwise contained within a bed frame, foundation, or bed support structure that supports the bed 112. Sometimes, the control box 124, the pump 120, or both can be located outside of a bed frame, foundation, or bed support structure (as shown in the example in FIG. 1).

The air bed system 100 in FIG. 2 includes the two air chambers 114A and 114B and the single pump 120 of the bed 112 depicted in FIG. 1. However, other implementations can include an air bed system having two or more air chambers and one or more pumps incorporated into the air bed system to control the air chambers. For example, a separate pump can be associated with each air chamber. As another example, a pump can be associated with multiple chambers. A first pump can be associated with air chambers that extend longitudinally from a left side to a midpoint of the air bed system 100 and a second pump can be associated with air chambers that extend longitudinally from a right side to the midpoint of the air bed system 100. Separate pumps can allow each air chamber to be inflated or deflated independently and/or simultaneously. Additional pressure transducers can also be incorporated into the air bed system 100 such that a separate pressure transducer can be associated with each air chamber.

As an illustrative example, in use, the processor 136 can send a decrease pressure command to one of air chambers 114A or 114B, and the switching mechanism 138 can convert the low voltage command signals sent by the processor 136 to higher operating voltages sufficient to operate the relief valve 144 of the pump 120 and open the respective control valve 145A or 145B. Opening the relief valve 144 can allow air to escape from the air chamber 114A or 114B through the respective air tube 148A or 148B.

During deflation, the pressure transducer 146 can send pressure readings to the processor 136 via the A/D converter 140. The A/D converter 140 can receive analog information from pressure transducer 146 and can convert the analog information to digital information useable by the processor 136. The processor 136 can send the digital signal to the remote control 122 to update the display 126 to convey the pressure information to the user. The processor 136 can also send the digital signal to other devices in wired or wireless communication with the air bed system, including but not limited to mobile devices described herein. The user can then view pressure information associated with the air bed system at their device instead of at, or in addition to, the remote control 122.

As another example, the processor 136 can send an increase pressure command. The pump motor 142 can be energized in response to the increase pressure command and send air to the designated one of the air chambers 114A or 114B through the air tube 148A or 148B via electronically operating the corresponding valve 145A or 145B. While air is being delivered to the designated air chamber 114A or 114B to increase the chamber firmness, the pressure transducer 146 can sense pressure within the pump manifold 143. The pressure transducer 146 can send pressure readings to the processor 136 via the A/D converter 140. The processor 136 can use the information received from the A/D converter 140 to determine the difference between the actual pressure in air chamber 114A or 114B and the desired pressure. The processor 136 can send the digital signal to the remote control 122 to update display 126.

Generally speaking, during an inflation or deflation process, the pressure sensed within the pump manifold 143 can provide an approximation of the actual pressure within the respective air chamber that is in fluid communication with the pump manifold 143. An example method includes turning off the pump 120, allowing the pressure within the air chamber 114A or 114B and the pump manifold 143 to equalize, then sensing the pressure within the pump manifold 143 with the pressure transducer 146. Providing a sufficient amount of time to allow the pressures within the pump manifold 143 and chamber 114A or 114B to equalize can result in pressure readings that are accurate approximations of actual pressure within air chamber 114A or 114B. In some implementations, the pressure of the air chambers 114A and/or 114B can be continuously monitored using multiple pressure sensors (not shown). The pressure sensors can be positioned within the air chambers. The pressure sensors can also be fluidly connected to the air chambers, such as along the air tubes 148A and 148B.

In some implementations, information collected by the pressure transducer 146 can be analyzed to determine various states of a user laying on the bed 112. For example, the processor 136 can use information collected by the pressure transducer 146 to determine a heartrate or a respiration rate for the user. As an illustrative example, the user can be laying on a side of the bed 112 that includes the chamber 114A. The pressure transducer 146 can monitor fluctuations in pressure of the chamber 114A, and this information can be used to determine the user's heartrate and/or respiration rate. As another example, additional processing can be performed using the collected data to determine a sleep state of the user (e.g., awake, light sleep, deep sleep). For example, the processor 136 can determine when the user falls asleep and, while asleep, the various sleep states (e.g., sleep stages) of the user. Based on the determined heartrate, respiration rate, and/or sleep states of the user, the processor 136 can determine information about the user's sleep quality. The processor 136 can, for example, determine how well the user slept during a particular sleep cycle. The processor 136 can also determine user sleep cycle trends. Accordingly, the processor 136 can generate recommendations to improve the user's sleep quality and overall sleep cycle. Information that is determined about the user's sleep cycle (e.g., heartrate, respiration rate, sleep states, sleep quality, recommendations to improve sleep quality, etc.) can be transmitted to the user's mobile device and presented in a mobile application, as described above.

Additional information associated with the user of the air bed system 100 that can be determined using information collected by the pressure transducer 146 includes user motion, presence on a surface of the bed 112, weight, heart arrhythmia, snoring, partner snore, and apnea. One or more other health conditions of the user can also be determined based on the information collected by the pressure transducer 146. Taking user presence detection for example, the pressure transducer 146 can be used to detect the user's presence on the bed 112, e.g., via a gross pressure change determination and/or via one or more of a respiration rate signal, heartrate signal, and/or other biometric signals. Detection of the user's presence can be beneficial to determine, by the processor 136, adjustment(s) to make to settings of the bed 112 (e.g., adjusting a firmness when the user is present to a user-preferred firmness setting) and/or peripheral devices (e.g., turning off lights when the user is present, activating a heating or cooling system, etc.).

For example, a simple pressure detection process can identify an increase in pressure as an indication that the user is present. As another example, the processor 136 can determine that the user is present if the detected pressure increases above a specified threshold (so as to indicate that a person or other object above a certain weight is positioned on the bed 112). As yet another example, the processor 136 can identify an increase in pressure in combination with detected slight, rhythmic fluctuations in pressure as corresponding to the user being present. The presence of rhythmic fluctuations can be identified as being caused by respiration or heart rhythm (or both) of the user. The detection of respiration or a heartbeat can distinguish between the user being present on the bed and another object (e.g., a suitcase, a pet, a pillow, etc.) being placed thereon.

In some implementations, pressure fluctuations can be measured at the pump 120. For example, one or more pressure sensors can be located within one or more internal cavities of the pump 120 to detect pressure fluctuations within the pump 120. The fluctuations detected at the pump 120 can indicate pressure fluctuations in the chambers 114A and/or 114B. One or more sensors located at the pump 120 can be in fluid communication with the chambers 114A and/or 114B, and the sensors can be operative to determine pressure within the chambers 114A and/or 114B. The control box 124 can be configured to determine at least one vital sign (e.g., heartrate, respiratory rate) based on the pressure within the chamber 114A or the chamber 114B.

The control box 124 can also analyze a pressure signal detected by one or more pressure sensors to determine a heartrate, respiration rate, and/or other vital signs of the user lying or sitting on the chamber 114A and/or 114B. More specifically, when a user lies on the bed 112 and is positioned over the chamber 114A, each of the user's heart beats, breaths, and other movements (e.g., hand, arm, leg, foot, or other gross body movements) can create a force on the bed 112 that is transmitted to the chamber 114A. As a result of this force input, a wave can propagate through the chamber 114A and into the pump 120. A pressure sensor located at the pump 120 can detect the wave, and thus the pressure signal outputted by the sensor can indicate a heartrate, respiratory rate, or other information regarding the user.

With regard to sleep state, the air bed system 100 can determine the user's sleep state by using various biometric signals such as heartrate, respiration, and/or movement of the user. While the user is sleeping, the processor 136 can receive one or more of the user's biometric signals (e.g., heartrate, respiration, motion, etc.) and can determine the user's present sleep state based on the received biometric signals. In some implementations, signals indicating fluctuations in pressure in one or both of the chambers 114A and 114B can be amplified and/or filtered to allow for more precise detection of heartrate and respiratory rate.

Sometimes, the processor 136 can receive additional biometric signals of the user from one or more other sensors or sensor arrays positioned on or otherwise integrated into the air bed system 100. For example, one or more sensors can be attached or removably attached to a top surface of the air bed system 100 and configured to detect signals such as heartrate, respiration rate, and/or motion. The processor 136 can combine biometric signals received from pressure sensors located at the pump 120, the pressure transducer 146, and/or the sensors positioned throughout the air bed system 100 to generate accurate and more precise information about the user and their sleep quality.

Sometimes, the control box 124 can perform a pattern recognition algorithm or other calculation based on the amplified and filtered pressure signal(s) to determine the user's heartrate and/or respiratory rate. For example, the algorithm or calculation can be based on assumptions that a heartrate portion of the signal has a frequency in a range of 0.5-4.0 Hz and that a respiration rate portion of the signal has a frequency in a range of less than 1 Hz. Sometimes, the control box 124 can use one or more machine learning models to determine the user's health information. The models can be trained using training data that includes training pressure signals and expected heartrates and/or respiratory rates. Sometimes, the control box 124 can determine user health information by using a lookup table that corresponds to sensed pressure signals.

The control box 124 can also be configured to determine other characteristics of the user based on the received pressure signal, such as blood pressure, tossing and turning movements, rolling movements, limb movements, weight, presence or lack of presence of the user, and/or the identity of the user.

For example, the pressure transducer 146 can be used to monitor the air pressure in the chambers 114A and 114B of the bed 112. If the user on the bed 112 is not moving, the air pressure changes in the air chamber 114A or 114B can be relatively minimal, and can be attributable to respiration and/or heartbeat. When the user on the bed 112 is moving, however, the air pressure in the mattress can fluctuate by a much larger amount. The pressure signals generated by the pressure transducer 146 and received by the processor 136 can be filtered and indicated as corresponding to motion, heartbeat, or respiration. The processor 136 can attribute such fluctuations in air pressure to the user's sleep quality. Such attributions can be determined based on applying one or more machine learning models and/or algorithms to the pressure signals. For example, if the user shifts and turns a lot during a sleep cycle (for example, in comparison to historic trends of the user's sleep cycles), the processor 136 can determine that the user experienced poor sleep during that particular sleep cycle.

In some implementations, rather than performing the data analysis in the control box 124 with the processor 136, a digital signal processor (DSP) can be provided to analyze the data collected by the pressure transducer 146. Alternatively, the collected data can be sent to a cloud-based computing system for remote analysis.

In some implementations, the example air bed system 100 further includes a temperature controller configured to increase, decrease, or maintain a temperature of the bed 112, for example for the comfort of the user. For example, a pad (e.g., mat, layer, etc.) can be placed on top of or be part of the bed 112, or can be placed on top of or be part of one or both of the chambers 114A and 114B. Air can be pushed through the pad and vented to cool off the user on the bed 112. Additionally or alternatively, the pad can include a heating element used to keep the user warm. In some implementations, the temperature controller can receive temperature readings from the pad. The temperature controller can determine whether the temperature readings are less than or greater than some threshold range and/or value. Based on this determination, the temperature controller can actuate components to push air through the pad to cool off the user or active the heating element. In some implementations, separate pads are used for different sides of the bed 112 (e.g., corresponding to the locations of the chambers 114A and 114B) to provide for differing temperature control for the different sides of the bed 112. Each pad can be selectively controlled by the temperature controller to provide cooling or heating preferred by each user on the different sides of the bed 112. For example, a first user on a left side of the bed 112 can prefer to have their side of the bed 112 cooled during the night while a second user on a right side of the bed 112 can prefer to have their side of the bed 112 warmed during the night.

In some implementations, the user of the air bed system 100 can use an input device, such as the remote control 122 or a mobile device as described above, to input a desired temperature for a surface of the bed 112 (or for a portion of the surface of the bed 112, for example at a foot region, a lumbar or waist region, a shoulder region, and/or a head region of the bed 112). The desired temperature can be encapsulated in a command data structure that includes the desired temperature and also identifies the temperature controller as the desired component to be controlled. The command data structure can then be transmitted via Bluetooth or another suitable communication protocol (e.g., WIFI, a local network, etc.) to the processor 136. In various examples, the command data structure is encrypted before being transmitted. The temperature controller can then configure its elements to increase or decrease the temperature of the pad depending on the temperature input provided at the remote control 122 by the user.

In some implementations, data can be transmitted from a component back to the processor 136 or to one or more display devices, such as the display 126 of the remote controller 122. For example, the current temperature as determined by a sensor element of a temperature controller, the pressure of the bed, the current position of the foundation or other information can be transmitted to control box 124. The control box 124 can transmit this information to the remote control 122 to be displayed to the user (e.g., on the display 126). As described above, the control box 124 can also transmit the received information to a mobile device to be displayed in a mobile application or other graphical user interface (GUI) to the user.

In some implementations, the example air bed system 100 further includes an adjustable foundation and an articulation controller configured to adjust the position of the bed 112 by adjusting the adjustable foundation supporting the bed. For example, the articulation controller can adjust the bed 112 from a flat position to a position in which a head portion of a mattress of the bed is inclined upward (e.g., to facilitate a user sitting up in bed and/or watching television). The bed 112 can also include multiple separately articulable sections. As an illustrative example, the bed 112 can include one or more of a head portion, a lumbar/waist portion, a leg portion, and/or a foot portion, all of which can be separately articulable. As another example, portions of the bed 112 corresponding to the locations of the chambers 114A and 114B can be articulated independently from each other, to allow one user positioned on the bed 112 surface to rest in a first position (e.g., a flat position or other desired position) while a second user rests in a second position (e.g., a reclining position with the head raised at an angle from the waist or another desired position). Separate positions can also be set for two different beds (e.g., two twin beds placed next to each other). The foundation of the bed 112 can include more than one zone that can be independently adjusted.

Sometimes, the bed 112 can be adjusted to one or more user-defined positions based on user input and/or user preferences. For example, the bed 112 can automatically adjust, by the articulation controller, to one or more user-defined settings. As another example, the user can control the articulation controller to adjust the bed 112 to one or more user-defined positions. Sometimes, the bed 112 can be adjusted to one or more positions that may provide the user with improved or otherwise improve sleep and sleep quality. For example, a head portion on one side of the bed 112 can be automatically articulated, by the articulation controller, when one or more sensors of the air bed system 100 detect that a user sleeping on that side of the bed 112 is snoring. As a result, the user's snoring can be mitigated so that the snoring does not wake up another user sleeping in the bed 112.

In some implementations, the bed 112 can be adjusted using one or more devices in communication with the articulation controller or instead of the articulation controller. For example, the user can change positions of one or more portions of the bed 112 using the remote control 122 described above. The user can also adjust the bed 112 using a mobile application or other graphical user interface presented at a mobile computing device of the user.

The articulation controller can also provide different levels of massage to one or more portions of the bed 112 for one or more users. The user(s) can adjust one or more massage settings for the portions of the bed 112 using the remote control 122 and/or a mobile device in communication with the air bed system 100.

### Example of a Bed in a Bedroom Environment

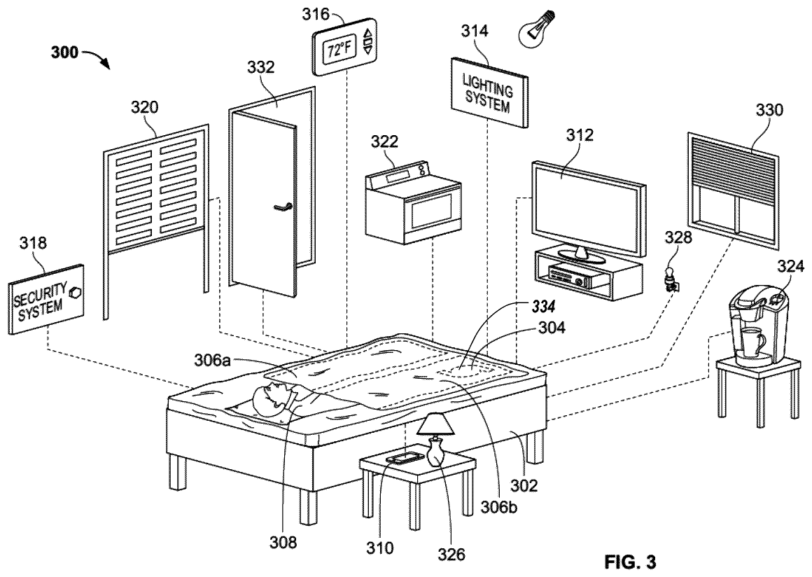

FIG. 3 shows an example environment 300 including a bed 302 in communication with devices located in and around a home. In the example shown, the bed 302 includes pump 304 for controlling air pressure within two air chambers 306a and 306b (as described above). The pump 304 additionally includes circuitry 334 for controlling inflation and deflation functionality performed by the pump 304. The circuitry 334 is programmed to detect fluctuations in air pressure of the air chambers 306a-b and use the detected fluctuations to identify bed presence of a user 308, the user's sleep state, movement, and biometric signals (e.g., heartrate, respiration rate). The detected fluctuations can also be used to detect when the user 308 is snoring and whether the user 308 has sleep apnea or other health conditions. The detected fluctuations can also be used to determine an overall sleep quality of the user 308.

In the example shown, the pump 304 is located within a support structure of the bed 302 and the control circuitry 334 for controlling the pump 304 is integrated with the pump 304. In some implementations, the control circuitry 334 is physically separate from the pump 304 and is in wireless or wired communication with the pump 304. In some implementations, the pump 304 and/or control circuitry 334 are located outside of the bed 302. In some implementations, various control functions can be performed by systems located in different physical locations. For example, circuitry for controlling actions of the pump 304 can be located within a pump casing of the pump 304 while control circuitry 334 for performing other functions associated with the bed 302 can be located in another portion of the bed 302, or external to the bed 302. The control circuitry 334 located within the pump 304 can also communicate with control circuitry 334 at a remote location through a LAN or WAN (e.g., the internet). The control circuitry 334 can also be included in the control box 124 of FIGS. 1 and 2.

In some implementations, one or more devices other than, or in addition to, the pump 304 and control circuitry 334 can be utilized to identify user bed presence, sleep state, movement, biometric signals, and other information (e.g., sleep quality, health related) about the user 308. For example, the bed 302 can include a second pump, with each pump connected to a respective one of the air chambers 306a-b. For example, the pump 304 can be in fluid communication with the air chamber 306b to control inflation and deflation of the air chamber 306b as well as detect user signals for a user located over the air chamber 306b. The second pump can be in fluid communication with the air chamber 306a and used to control inflation and deflation of the air chamber 306a as well as detect user signals for a user located over the air chamber 306a.

As another example, the bed 302 can include one or more pressure sensitive pads or surface portions operable to detect movement, including user presence, motion, respiration, and heartrate. A first pressure sensitive pad can be incorporated into a surface of the bed 302 over a left portion of the bed 302, where a first user would normally be located during sleep, and a second pressure sensitive pad can be incorporated into the surface of the bed 302 over a right portion of the bed 302, where a second user would normally be located. The movement detected by the pressure sensitive pad(s) or surface portion(s) can be used by control circuitry 334 to identify user sleep state, bed presence, or biometric signals for each user. The pressure sensitive pads can also be removable rather than incorporated into the surface of the bed 302.

The bed 302 can also include one or more temperature sensors and/or array of sensors operable to detect temperatures in microclimates of the bed 302. Detected temperatures in different microclimates of the bed 302 can be used by the control circuitry 334 to determine one or more modifications to the user 308's sleep environment. For example, a temperature sensor located near a core region of the bed 302 where the user 308 rests can detect high temperature values. Such high temperature values can indicate that the user 308 is warm. To lower the user's body temperature in this microclimate, the control circuitry 334 can determine that a cooling element of the bed 302 can be activated. As another example, the control circuitry 334 can determine that a cooling unit in the home can be automatically activated to cool an ambient temperature in the environment 300.

The control circuitry 334 can also process a combination of signals sensed by different sensors that are integrated into, positioned on, or otherwise in communication with the bed 112. For example, pressure and temperature signals can be processed by the control circuitry 334 to more accurately determine one or more health conditions of the user 308 and/or sleep quality of the user 308. Acoustic signals detected by one or more microphones or other audio sensors can also be used in combination with pressure or motion sensors in order to determine when the user 308 snores, whether the user 308 has sleep apnea, and/or overall sleep quality of the user 308. Combinations of one or more other sensed signals are also possible for the control circuitry 334 to more accurately determine one or more health and/or sleep conditions of the user 308.

Accordingly, information detected by one or more sensors or other components of the bed 112 (e.g., motion information) can be processed by the control circuitry 334 and provided to one or more user devices, such as a user device 310 for presentation to the user 308 or to other users. The information can be presented in a mobile application or other graphical user interface at the user device 310. The user 308 can view different information that is processed and/or determined by the control circuitry 334 and based the signals that are detected by components of the bed 302. For example, the user 308 can view their overall sleep quality for a particular sleep cycle (e.g., the previous night), historic trends of their sleep quality, and health information. The user 308 can also adjust one or more settings of the bed 302 (e.g., increase or decrease pressure in one or more regions of the bed 302, incline or decline different regions of the bed 302, turn on or off massage features of the bed 302, etc.) using the mobile application that is presented at the user device 310.

In the example depicted in FIG. 3, the user device 310 is a mobile phone; however, the user device 310 can also be any one of a tablet, personal computer, laptop, a smartphone, a smart television (e.g., a television 312), a home automation device, or other user device capable of wired or wireless communication with the control circuitry 334, one or more other components of the bed 302, and/or one or more devices in the environment 300. The user device 310 can be in communication with the control circuitry 334 of the bed 302 through a network or through direct point-to-point communication. For example, the control circuitry 334 can be connected to a LAN (e.g., through a WIFI router) and communicate with the user device 310 through the LAN. As another example, the control circuitry 334 and the user device 310 can both connect to the Internet and communicate through the Internet. For example, the control circuitry 334 can connect to the Internet through a WIFI router and the user device 310 can connect to the Internet through communication with a cellular communication system. As another example, the control circuitry 334 can communicate directly with the user device 310 through a wireless communication protocol, such as Bluetooth. As yet another example, the control circuitry 334 can communicate with the user device 310 through a wireless communication protocol, such as ZigBee, Z-Wave, infrared, or another wireless communication protocol suitable for the application. As another example, the control circuitry 334 can communicate with the user device 310 through a wired connection such as, for example, a USB connector, serial/RS232, or another wired connection suitable for the application.

As mentioned above, the user device 310 can display a variety of information and statistics related to sleep, or user 308's interaction with the bed 302. For example, a user interface displayed by the user device 310 can present information including amount of sleep for the user 308 over a period of time (e.g., a single evening, a week, a month, etc.), amount of deep sleep, ratio of deep sleep to restless sleep, time lapse between the user 308 getting into bed and falling asleep, total amount of time spent in the bed 302 for a given period of time, heartrate over a period of time, respiration rate over a period of time, or other information related to user interaction with the bed 302 by the user 308 or one or more other users. In some implementations, information for multiple users can be presented on the user device 310, for example information for a first user positioned over the air chamber 306a can be presented along with information for a second user positioned over the air chamber 306b. In some implementations, the information presented on the user device 310 can vary according to the age of the user 308 so that the information presented evolves with the age of the user 308.

The user device 310 can also be used as an interface for the control circuitry 334 of the bed 302 to allow the user 308 to enter information and/or adjust one or more settings of the bed 302. The information entered by the user 308 can be used by the control circuitry 334 to provide better information to the user 308 or to various control signals for controlling functions of the bed 302 or other devices. For example, the user 308 can enter information such as weight, height, and age of the user 308. The control circuitry 334 can use this information to provide the user 308 with a comparison of the user 308's tracked sleep information to sleep information of other people having similar weights, heights, and/or ages as the user 308. The control circuitry 308 can also use this information to accurately determine overall sleep quality and/or health of the user 308 based on information detected by components (e.g., sensors) of the bed 302.

The user 308 may also use the user device 310 as an interface for controlling air pressure of the air chambers 306a and 306b, various recline or incline positions of the bed 302, temperature of one or more surface temperature control devices of the bed 302, or for allowing the control circuitry 334 to generate control signals for other devices (as described below).

The control circuitry 334 may also communicate with other devices or systems, including but not limited to the television 312, a lighting system 314, a thermostat 316, a security system 318, home automation devices, and/or other household devices (e.g., an oven 322, a coffee maker 324, a lamp 326, a nightlight 328). Other examples of devices and/or systems include a system for controlling window blinds 330, devices for detecting or controlling states of one or more doors 332 (such as detecting if a door is open, detecting if a door is locked, or automatically locking a door), and a system for controlling a garage door 320 (e.g., control circuitry 334 integrated with a garage door opener for identifying an open or closed state of the garage door 320 and for causing the garage door opener to open or close the garage door 320). Communications between the control circuitry 334 and other devices can occur through a network (e.g., a LAN or the Internet) or as point-to-point communication (e.g., BLUETOOTH, radio communication, or a wired connection). Control circuitry 334 of different beds 302 can also communicate with different sets of devices. For example, a kid's bed may not communicate with and/or control the same devices as an adult bed. In some embodiments, the bed 302 can evolve with the age of the user such that the control circuitry 334 of the bed 302 communicates with different devices as a function of age of the user of that bed 302.

The control circuitry 334 can receive information and inputs from other devices/systems and use the received information and inputs to control actions of the bed 302 and/or other devices. For example, the control circuitry 334 can receive information from the thermostat 316 indicating a current environmental temperature for a house or room in which the bed 302 is located. The control circuitry 334 can use the received information (along with other information, such as signals detected from one or more sensors of the bed 302) to determine if a temperature of all or a portion of the surface of the bed 302 should be raised or lowered. The control circuitry 334 can then cause a heating or cooling mechanism of the bed 302 to raise or lower the temperature of the surface of the bed 302. The control circuitry 334 can also cause a heating or cooling unit of the house or room in which the bed 302 is located to raise or lower the ambient temperature surrounding the bed 302. Thus, by adjusting the temperature of the bed 302 and/or the room in which the bed 302 is located, the user 308 can experience more improved sleep quality and comfort.

As an example, the user 308 can indicate a desired sleeping temperature of 74 degrees while a second user of the bed 302 indicates a desired sleeping temperature of 72 degrees. The thermostat 316 can transmit signals indicating room temperature at predetermined times to the control circuitry 334. The thermostat 316 can also send a continuous stream of detected temperature values of the room to the control circuitry 334. The transmitted signal(s) can indicate to the control circuitry 334 that the current temperature of the bedroom is 72 degrees. The control circuitry 334 can identify that the user 308 has indicated a desired sleeping temperature of 74 degrees, and can accordingly send control signals to a heating pad located on the user 308's side of the bed to raise the temperature of the portion of the surface of the bed 302 where the user 308 is located until the user 308's desired temperature is achieved. Moreover, the control circuitry 334 can sent control signals to the thermostat 316 and/or a heating unit in the house to raise the temperature in the room in which the bed 302 is located.

The control circuitry 334 can generate control signals to control other devices and propagate the control signals to the other devices. The control signals can be generated based on information collected by the control circuitry 334, including information related to user interaction with the bed 302 by the user 308 and/or one or more other users. Information collected from other devices other than the bed 302 can also be used when generating the control signals. For example, information relating to environmental occurrences (e.g., environmental temperature, environmental noise level, and environmental light level), time of day, time of year, day of the week, or other information can be used when generating control signals for various devices in communication with the control circuitry 334 of the bed 302.

For example, information on the time of day can be combined with information relating to movement and bed presence of the user 308 to generate control signals for the lighting system 314. The control circuitry 334 can, based on detected pressure signals of the user 308 on the bed 302, determine when the user 308 is presently in the bed 302 and when the user 308 falls asleep. Once the control circuitry 334 determines that the user has fallen asleep, the control circuitry 334 can transmit control signals to the lighting system 314 to turn off lights in the room in which the bed 302 is located, to lower the window blinds 330 in the room, and/or to activate the nightlight 328. Moreover, the control circuitry 334 can receive input from the user 308 (e.g., via the user device 310) that indicates a time at which the user 308 would like to wake up. When that time approaches, the control circuitry 334 can transmit control signals to one or more devices in the environment 300 to control devices that may cause the user 308 to wake up. For example, the control signals can be sent to a home automation device that controls multiple devices in the home. The home automation device can be instructed, by the control circuitry 334, to raise the window blinds 330, turn off the nightlight 328, turn on lighting beneath the bed 302, start the coffee machine 324, change a temperature in the house via the thermostat 316, or perform some other home automation. The home automation device can also be instructed to activate an alarm that can cause the user 308 to wake up. Sometimes, the user 308 can input information at the user device 310 that indicates what actions can be taken by the home automation device or other devices in the environment 300.

In some implementations, rather than or in addition to providing control signals for other devices, the control circuitry 334 can provide collected information (e.g., information related to user movement, bed presence, sleep state, or biometric signals) to one or more other devices to allow the one or more other devices to utilize the collected information when generating control signals. For example, the control circuitry 334 of the bed 302 can provide information relating to user interactions with the bed 302 by the user 308 to a central controller (not shown) that can use the provided information to generate control signals for various devices, including the bed 302.

The central controller can, for example, be a hub device that provides a variety of information about the user 308 and control information associated with the bed 302 and other devices in the house. The central controller can include sensors that detect signals that can be used by the control circuitry 334 and/or the central controller to determine information about the user 308 (e.g., biometric or other health data, sleep quality). The sensors can detect signals including such as ambient light, temperature, humidity, volatile organic compound(s), pulse, motion, and audio. These signals can be combined with signals detected by sensors of the bed 302 to determine accurate information about the user 308's health and sleep quality. The central controller can provide controls (e.g., user-defined, presets, automated, user initiated) for the bed 302, determining and viewing sleep quality and health information, a smart alarm clock, a speaker or other home automation device, a smart picture frame, a nightlight, and one or more mobile applications that the user 308 can install and use at the central controller. The central controller can include a display screen that outputs information and receives user input. The display can output information such as the user 308's health, sleep quality, weather, security integration features, lighting integration features, heating and cooling integration features, and other controls to automate devices in the house. The central controller can operate to provide the user 308 with functionality and control of multiple different types of devices in the house as well as the user 308's bed 302.

As an illustrative example of FIG. 3, the control circuitry 334 integrated with the pump 304 can detect a feature of a mattress of the bed 302, such as an increase in pressure in the air chamber 306b, and use this detected increase to determine that the user 308 is present on the bed 302. The control circuitry 334 may also identify a heartrate or respiratory rate for the user 308 to identify that the increased pressure is due to a person sitting, laying, or resting on the bed 302, rather than an inanimate object (e.g., a suitcase) having been placed on the bed 302. In some implementations, the information indicating user bed presence can be combined with other information to identify a current or future likely state for the user 308. For example, a detected user bed presence at 11:00 am can indicate that the user is sitting on the bed (e.g., to tie her shoes, or to read a book) and does not intend to go to sleep, while a detected user bed presence at 10:00 pm can indicate that the user 308 is in bed for the evening and is intending to fall asleep soon. As another example, if the control circuitry 334 detects that the user 308 has left the bed 302 at 6:30 am (e.g., indicating that the user 308 has woken up for the day), and then later detects presence of the user 308 at 7:30 am on the bed 302, the control circuitry 334 can use this information that the newly detected presence is likely temporary (e.g., while the user 308 ties her shoes before heading to work) rather than an indication that the user 308 is intending to stay on the bed 302 for an extended period of time.

If the control circuitry 334 determines that the user 308 is likely to remain on the bed 302 for an extended period of time, the control circuitry 334 can determine one or more home automation controls that can aid the user 308 in falling asleep and experience improved sleep quality throughout the user 308's sleep cycle. For example, the control circuitry 334 can communicate with security system 318 to ensure that doors are locked. The control circuitry 334 can communicate with the oven 322 to ensure that the oven 322 is turned off. The control circuitry 334 can also communicate with the lighting system 314 to dim or otherwise turn off lights in the room in which the bed 302 is located and/or throughout the house, and the control circuitry 334 can communicate with the thermostat 316 to ensure that the house is at a desired temperature of the user 308. The control circuitry 334 can also determine one or more adjustments that can be made to the bed 302 to facilitate the user 308 falling asleep and staying asleep (e.g., changing a position of one or more regions of the bed 302, foot warming, massage features, pressure/firmness in one or more regions of the bed 302, etc.).

In some implementations, the control circuitry 334 may use collected information (including information related to user interaction with the bed 302 by the user 308, environmental information, time information, and user input) to identify use patterns for the user 308. For example, the control circuitry 334 can use information indicating bed presence and sleep states for the user 308 collected over a period of time to identify a sleep pattern for the user. The control circuitry 334 can identify that the user 308 generally goes to bed between 9:30 pm and 10:00 pm, generally falls asleep between 10:00 pm and 11:00 pm, and generally wakes up between 6:30 am and 6:45 am, based on information indicating user presence and biometrics for the user 308 collected over a week or a different time period. The control circuitry 334 can use identified patterns of the user 308 to better process and identify user interactions with the bed 302.

Given the above example user bed presence, sleep, and wake patterns for the user 308, if the user 308 is detected as being on the bed 302 at 3:00 pm, the control circuitry 334 can determine that the user 308's presence on the bed 302 is temporary, and use this determination to generate different control signals than if the control circuitry 334 determined the user 308 was in bed for the evening (e.g., at 3:00 pm, a head region of the bed 302 can be raised to facilitate reading or watching TV while in the bed 302, whereas in the evening, the bed 302 can be adjusted to a flat position to facilitate falling asleep). As another example, if the control circuitry 334 detects that the user 308 got out of bed at 3:00 am, the control circuitry 334 can use identified patterns for the user 308 to determine the user has gotten up temporarily (e.g., to use the bathroom, get a glass of water). The control circuitry 334 can turn on underbed lighting to assist the user 308 in carefully moving around the bed 302 and room. By contrast, if the control circuitry 334 identifies that the user 308 got out of the bed 302 at 6:40 am, the control circuitry 334 can determine the user 308 is up for the day and generate a different set of control signals (e.g., the control circuitry 334 can turn on light 326 near the bed 302 and/or raise the window blinds 330). For other users, getting out of the bed 302 at 3:00 am can be a normal wake-up time, which the control circuitry 334 can learn and respond to accordingly. Moreover, if the bed 302 is occupied by two users, the control circuitry 334 can learn and respond to the patterns of each of the users.

The bed 302 can also generate control signals based on communication with one or more devices. As an illustrative example, the control circuitry 334 can receive an indication from the television 312 that the television 312 is turned on. If the television 312 is located in a different room than the bed 302, the control circuitry 334 can generate a control signal to turn the television 312 off upon making a determination that the user 308 has gone to bed for the evening or otherwise is remaining in the room with the bed 302. If presence of the user 308 is detected on the bed 302 during a particular time range (e.g., between 8:00 pm and 7:00 am) and persists for longer than a threshold period of time (e.g., 10 minutes), the control circuitry 334 can determine the user 308 is in bed for the evening. If the television 312 is on, as described above, the control circuitry 334 can generate a control signal to turn the television 312 off. The control signals can be transmitted to the television (e.g., through a directed communication link or through a network, such as WIFI). As another example, rather than turning off the television 312 in response to detection of user bed presence, the control circuitry 334 can generate a control signal that causes the volume of the television 312 to be lowered by a pre-specified amount.

As another example, upon detecting that the user 308 has left the bed 302 during a specified time range (e.g., between 6:00 am and 8:00 am), the control circuitry 334 can generate control signals to cause the television 312 to turn on and tune to a pre-specified channel (e.g., the user 308 indicated a preference for watching morning news upon getting out of bed). The control circuitry 334 can accordingly generate and transmit the control signal to the television 312 (which can be stored at the control circuitry 334, the television 312, or another location). As another example, upon detecting that the user 308 has gotten up for the day, the control circuitry 334 can generate and transmit control signals to cause the television 312 to turn on and begin playing a previously recorded program from a digital video recorder (DVR) in communication with the television 312.

As another example, if the television 312 is in the same room as the bed 302, the control circuitry 334 may not cause the television 312 to turn off in response to detection of user bed presence. Rather, the control circuitry 334 can generate and transmit control signals to cause the television 312 to turn off in response to determining that the user 308 is asleep. For example, the control circuitry 334 can monitor biometric signals of the user 308 (e.g., motion, heartrate, respiration rate) to determine that the user 308 has fallen asleep. Upon detecting that the user 308 is sleeping, the control circuitry 334 generates and transmits a control signal to turn the television 312 off. As another example, the control circuitry 334 can generate the control signal to turn off the television 312 after a threshold period of time has passed since the user 308 has fallen asleep (e.g., 10 minutes after the user has fallen asleep). As another example, the control circuitry 334 generates control signals to lower the volume of the television 312 after determining that the user 308 is asleep. As yet another example, the control circuitry 334 generates and transmits a control signal to cause the television to gradually lower in volume over a period of time and then turn off in response to determining that the user 308 is asleep. Any of the control signals described above in reference to the television 312 can also be determined by the central controller previously described.

In some implementations, the control circuitry 334 can similarly interact with other media devices, such as computers, tablets, mobile phones, smart phones, wearable devices, stereo systems, etc. For example, upon detecting that the user 308 is asleep, the control circuitry 334 can generate and transmit a control signal to the user device 310 to cause the user device 310 to turn off, or turn down the volume on a video or audio file being played by the user device 310.

The control circuitry 334 can additionally communicate with the lighting system 314, receive information from the lighting system 314, and generate control signals for controlling functions of the lighting system 314. For example, upon detecting user bed presence on the bed 302 during a certain time frame (e.g., between 8:00 pm and 7:00 am) that lasts for longer than a threshold period of time (e.g., 10 minutes), the control circuitry 334 of the bed 302 can determine that the user 308 is in bed for the evening and generate control signals to cause lights in one or more rooms other than the room in which the bed 302 is located to switch off. The control circuitry 334 can generate and transmit control signals to turn off lights in all common rooms, but not in other bedrooms. As another example, the control signals can indicate that lights in all rooms other than the room in which the bed 302 is located are to be turned off, while one or more lights located outside of the house containing the bed 302 are to be turned on. The control circuitry 334 can generate and transmit control signals to cause the nightlight 328 to turn on in response to determining user 308 bed presence or that the user 308 is asleep. The control circuitry 334 can also generate first control signals for turning off a first set of lights (e.g., lights in common rooms) in response to detecting user bed presence, and second control signals for turning off a second set of lights (e.g., lights in the room where the bed 302 is located) when detecting that the user 308 is asleep.

In some implementations, in response to determining that the user 308 is in bed for the evening, the control circuitry 334 of the bed 302 can generate control signals to cause the lighting system 314 to implement a sunset lighting scheme in the room in which the bed 302 is located. A sunset lighting scheme can include, for example, dimming the lights (either gradually over time, or all at once) in combination with changing the color of the light in the bedroom environment, such as adding an amber hue to the lighting in the bedroom. The sunset lighting scheme can help to put the user 308 to sleep when the control circuitry 334 has determined that the user 308 is in bed for the evening. Sometimes, the control signals can cause the lighting system 314 to dim the lights or change color of the lighting in the bedroom environment, but not both.

The control circuitry 334 can also implement a sunrise lighting scheme when the user 308 wakes up in the morning. The control circuitry 334 can determine that the user 308 is awake for the day, for example, by detecting that the user 308 has gotten off the bed 302 (e.g., is no longer present on the bed 302) during a specified time frame (e.g., between 6:00 am and 8:00 am). The control circuitry 334 can also monitor movement, heartrate, respiratory rate, or other biometric signals of the user 308 to determine that the user 308 is awake or is waking up, even though the user 308 has not gotten out of bed. If the control circuitry 334 detects that the user is awake or waking up during a specified timeframe, the control circuitry 334 can determine that the user 308 is awake for the day. The specified timeframe can be, for example, based on previously recorded user bed presence information collected over a period of time (e.g., two weeks) that indicates that the user 308 usually wakes up for the day between 6:30 am and 7:30 am. In response to the control circuitry 334 determining that the user 308 is awake, the control circuitry 334 can generate control signals to cause the lighting system 314 to implement the sunrise lighting scheme in the bedroom in which the bed 302 is located. The sunrise lighting scheme can include, for example, turning on lights (e.g., the lamp 326, or other lights in the bedroom). The sunrise lighting scheme can further include gradually increasing the level of light in the room where the bed 302 is located (or in one or more other rooms). The sunrise lighting scheme can also include only turning on lights of specified colors. The sunrise lighting scheme can include lighting the bedroom with blue light to gently assist the user 308 in waking up and becoming active.

The control circuitry 334 may also generate different control signals for controlling actions of components depending on a time of day that user interactions with the bed 302 are detected. For example, the control circuitry 334 can use historical user interaction information to determine that the user 308 usually falls asleep between 10:00 pm and 11:00 pm and usually wakes up between 6:30 am and 7:30 am on weekdays. The control circuitry 334 can use this information to generate a first set of control signals for controlling the lighting system 314 if the user 308 is detected as getting out of bed at 3:00 am (e.g., turn on lights that guide the user 308 to a bathroom or kitchen) and to generate a second set of control signals for controlling the lighting system 314 if the user 308 is detected as getting out of bed after 6:30 am.

In some implementations, if the user 308 is detected as getting out of bed prior to a specified morning rise time for the user 308, the control circuitry 334 can cause the lighting system 314 to turn on lights that are dimmer than lights that are turned on by the lighting system 314 if the user 308 is detected as getting out of bed after the specified morning rise time. Causing the lighting system 314 to only turn on dim lights when the user 308 gets out of bed during the night (e.g., prior to normal rise time for the user 308) can prevent other occupants of the house from being woken up by the lights while still allowing the user 308 to see in order to reach their destination in the house.

The historical user interaction information for interactions between the user 308 and the bed 302 can be used to identify user sleep and awake timeframes. For example, user bed presence times and sleep times can be determined for a set period of time (e.g., two weeks, a month, etc.). The control circuitry 334 can identify a typical time range or timeframe in which the user 308 goes to bed, a typical timeframe for when the user 308 falls asleep, and a typical timeframe for when the user 308 wakes up (and in some cases, different timeframes for when the user 308 wakes up and when the user 308 actually gets out of bed). Buffer time may be added to these timeframes. For example, if the user is identified as typically going to bed between 10:00 pm and 10:30 pm, a buffer of a half hour in each direction can be added to the timeframe such that any detection of the user getting in bed between 9:30 pm and 11:00 pm is interpreted as the user 308 going to bed for the evening. As another example, detection of bed presence of the user 308 starting from a half hour before the earliest typical time that the user 308 goes to bed extending until the typical wake up time (e.g., 6:30 am) for the user 308 can be interpreted as the user 308 going to bed for the evening. For example, if the user 308 typically goes to bed between 10:00 pm and 10:30 pm, if the user 308's bed presence is sensed at 12:30 am one night, that can be interpreted as the user 308 getting into bed for the evening even though this is outside of the user 308's typical timeframe for going to bed because it has occurred prior to the user 308's normal wake up time. In some implementations, different timeframes are identified for different times of year (e.g., earlier bed time during winter vs. summer) or at different times of the week (e.g., user 308 wakes up earlier on weekdays than on weekends).

The control circuitry 334 can distinguish between the user 308 going to bed for an extended period (e.g., for the night) as opposed to being present on the bed 302 for a shorter period (e.g., for a nap) by sensing duration of presence of the user 308 (e.g., by detecting pressure and/or temperature signals of the user 308 on the bed 302 by sensors integrated into the bed 302). In some examples, the control circuitry 334 can distinguish between the user 308 going to bed for an extended period (e.g., for the night) versus going to bed for a shorter period (e.g., for a nap) by sensing duration of the user 308's sleep. The control circuitry 334 can set a time threshold whereby if the user 308 is sensed on the bed 302 for longer than the threshold, the user 308 is considered to have gone to bed for the night. In some examples, the threshold can be about 2 hours, whereby if the user 308 is sensed on the bed 302 for greater than 2 hours, the control circuitry 334 registers that as an extended sleep event. In other examples, the threshold can be greater than or less than two hours. The threshold can be determined based on historic trends indicating how long the user 302 usually sleeps or otherwise stays on the bed 302.

The control circuitry 334 can detect repeated extended sleep events to automatically determine a typical bed time range of the user 308, without requiring the user 308 to enter a bed time range. This can allow the control circuitry 334 to accurately estimate when the user 308 is likely to go to bed for an extended sleep event, regardless of whether the user 308 typically goes to bed using a traditional sleep schedule or a non-traditional sleep schedule. The control circuitry 334 can then use knowledge of the bed time range of the user 308 to control one or more components (including components of the bed 302 and/or non-bed peripherals) based on sensing bed presence during the bed time range or outside of the bed time range.

The control circuitry 334 can automatically determine the bed time range of the user 308 without requiring user inputs. The control circuitry 334 may also determine the bed time range automatically and in combination with user inputs (e.g., using signals sensed by sensors of the bed 302 and/or the central controller). The control circuitry 334 can set the bed time range directly according to user inputs. The control circuitry 334 can associate different bed times with different days of the week. In each of these examples, the control circuitry 334 can control components (e.g., the lighting system 314, thermostat 316, security system 318, oven 322, coffee maker 324, lamp 326, nightlight 328), as a function of sensed bed presence and the bed time range. The control circuitry 334 can also determine control signals to be

transmitted to the thermostat 316 based on user-inputted preferences and/or maintaining improved or preferred sleep quality of the user 308. For example, the control circuitry 334 can determine, based on historic sleep patterns and quality of the user 308 and by applying machine learning models, that the user 308 experiences their best sleep when the bedroom is at 74 degrees. The control circuitry 334 can receive temperature signals from devices and/or sensors in the bedroom indicating a bedroom temperature. When the temperature is below 74 degrees, the control circuitry 334 can determine control signals that cause the thermostat 316 to activate a heating unit to raise the temperature to 74 degrees in the bedroom. When the temperature is above 74 degrees, the control circuitry 334 can determine control signals that cause the thermostat 316 to activate a cooling unit to lower the temperature back to 74 degrees. Sometimes, the control circuitry 334 can determine control signals that cause the thermostat 316 to maintain the bedroom within a temperature range intended to keep the user 308 in particular sleep states and/or transition to next preferred sleep states.

Similarly, the control circuitry 334 can generate control signals to cause heating or cooling elements on the surface of the bed 302 to change temperature at various times, either in response to user interaction with the bed 302, at various pre-programmed times, based on user preference, and/or in response to detecting microclimate temperatures of the user 308 on the bed 302. For example, the control circuitry 334 can activate a heating element to raise the temperature of one side of the surface of the bed 302 to 73 degrees when it is detected that the user 308 has fallen asleep. As another example, upon determining that the user 308 is up for the day, the control circuitry 334 can turn off a heating or cooling element. The user 308 can pre-program various times at which the temperature at the bed surface should be raised or lowered. As another example, temperature sensors on the bed surface can detect microclimates of the user 308. When a detected microclimate drops below a predetermined threshold temperature, the control circuitry 334 can activate a heating element to raise the user 308's body temperature, thereby improving the user 308's comfortability, maintaining their sleep cycle, transitioning the user 308 to a next preferred sleep state, and/or maintaining or improving the user 308's sleep quality.

In response to detecting user bed presence and/or that the user 308 is asleep, the control circuitry 334 can also cause the thermostat 316 to change the temperature in different rooms to different values. Other control signals are also possible, and can be based on user preference and user input. Moreover, the control circuitry 334 can receive temperature information from the thermostat 316 and use this information to control functions of the bed 302 or other devices (e.g., adjusting temperatures of heating elements of the bed 302, such as a foot warming pad). The control circuitry 334 may also generate and transmit control signals for controlling other temperature control systems, such as floor heating elements in the bedroom or other rooms.

The control circuitry 334 can communicate with the security system 318, receive information from the security system 318, and generate control signals for controlling functions of the security system 318. For example, in response to detecting that the user 308 in is bed for the evening, the control circuitry 334 can generate control signals to cause the security system 318 to engage or disengage security functions. As another example, the control circuitry 334 can generate and transmit control signals to cause the security system 318 to disable in response to determining that the user 308 is awake for the day (e.g., user 308 is no longer present on the bed 302).

The control circuitry 334 can also receive alerts from the security system 318 and indicate the alert to the user 308. For example, the security system can detect a security breach (e.g., someone opened the door 332 without entering the security code, someone opened a window when the security system 318 is engaged) and communicate the security breach to the control circuitry 334. The control circuitry 334 can then generate control signals to alert the user 308, such as causing the bed 302 to vibrate, causing portions of the bed 302 to articulate (e.g., the head section to raise or lower), causing the lamp 326 to flash on and off at regular intervals, etc. The control circuitry 334 can also alert the user 308 of one bed 302 about a security breach in another bedroom, such as an open window in a kid's bedroom. The control circuitry 334 can send an alert to a garage door controller (e.g., to close and lock the door). The control circuitry 334 can send an alert for the security to be disengaged. The control circuitry 334 can also set off a smart alarm or other alarm device/clock near the bed 302. The control circuitry 334 can transmit a push notification, text message, or other indication of the security breach to the user device 310. Also, the control circuitry 334 can transmit a notification of the security breach to the central controller, which can then determine one or more responses to the security breach.

The control circuitry 334 can additionally generate and transmit control signals for controlling the garage door 320 and receive information indicating a state of the garage door 320 (e.g., open or closed). The control circuitry 334 can also request information on a current state of the garage door 320. If the control circuitry 334 receives a response (e.g., from the garage door opener) that the garage door 320 is open, the control circuitry 334 can notify the user 308 that the garage door is open (e.g., by displaying a notification or other message at the user device 310, outputting a notification at the central controller), and/or generate a control signal to cause the garage door opener to close the door. The control circuitry 334 can also cause the bed 302 to vibrate, cause the lighting system 314 to flash lights in the bedroom, etc. Control signals can also vary depend on the age of the user 308. Similarly, the control circuitry 334 can similarly send and receive communications for controlling or receiving state information associated with the door 332 or the oven 322.

In some implementations, different alerts can be generated for different events. For example, the control circuitry 334 can cause the lamp 326 (or other lights, via the lighting system 314) to flash in a first pattern if the security system 318 has detected a breach, flash in a second pattern if garage door 320 is on, flash in a third pattern if the door 332 is open, flash in a fourth pattern if the oven 322 is on, and flash in a fifth pattern if another bed has detected that a user 308 of that bed has gotten up (e.g., a child has gotten out of bed in the middle of the night as sensed by a sensor in the child's bed). Other examples of alerts include a smoke detector detecting smoke (and communicating this detection to the control circuitry 334), a carbon monoxide tester, a heater malfunctioning, or an alert from another device capable of communicating with the control circuitry 334 and detecting an occurrence to bring to the user 308's attention.

The control circuitry 334 can also communicate with a system or device for controlling a state of the window blinds 330. For example, in response to determining that the user 308 is up for the day or that the user 308 set an alarm to wake up at a particular time, the control circuitry 334 can generate and transmit control signals to cause the window blinds 330 to open. By contrast, if the user 308 gets out of bed prior to a normal rise time for the user 308, the control circuitry 334 can determine that the user 308 is not awake for the day and may not generate control signals that cause the window blinds 330 to open. The control circuitry 334 can also generate and transmit control signals that cause a first set of blinds to close in response to detecting user bed presence and a second set of blinds to close in response to detecting that the user 308 is asleep.

As other examples, in response to determining that the user 308 is awake for the day, the control circuitry 334 can generate and transmit control signals to the coffee maker 324 to cause the coffee maker 324 to brew coffee. The control circuitry 334 can generate and transmit control signals to the oven 322 to cause the oven 322 to begin preheating. The control circuitry 334 can use information indicating that the user 308 is awake for the day along with information indicating that the time of year is currently winter and/or that the outside temperature is below a threshold value to generate and transmit control signals to cause a car engine block heater to turn on. The control circuitry 334 can generate and transmit control signals to cause devices to enter a sleep mode in response to detecting user bed presence, or in response to detecting that the user 308 is asleep (e.g., causing a mobile phone of the user 308 to switch into sleep or night mode so that notifications are muted to not disturb the user 308's sleep). Later, upon determining that the user 308 is up for the day, the control circuitry 334 can generate and transmit control signals to cause the mobile phone to switch out of sleep/night mode.

The control circuitry 334 can also communicate with one or more noise control devices. For example, upon determining that the user 308 is in bed for the evening, or that the user 308 is asleep (e.g., based on pressure signals received from the bed 302, audio/decibel signals received from audio sensors positioned on or around the bed 302), the control circuitry 334 can generate and transmit control signals to cause noise cancelation devices to activate. The noise cancelation devices can be part of the bed 302 or located in the bedroom. Upon determining that the user 308 is in bed for the evening or that the user 308 is asleep, the control circuitry 334 can generate and transmit control signals to turn the volume on, off, up, or down, for one or more sound generating devices, such as a stereo system radio, television, computer, tablet, mobile phone, etc.

Additionally, functions of the bed 302 can be controlled by the control circuitry 334 in response to user interactions. For example, the articulation controller can adjust the bed 302 from a flat position to a position in which a head portion of a mattress of the bed 302 is inclined upward (e.g., to facilitate a user sitting up in bed, reading, and/or watching television). Sometimes, the bed 302 includes multiple separately articulable sections. Portions of the bed corresponding to the locations of the air chambers 306a and 306b can be articulated independently from each other, to allow one person to rest in a first position (e.g., a flat position) while a second person rests in a second position (e.g., a reclining position with the head raised at an angle from the waist). Separate positions can be set for two different beds (e.g., two twin beds placed next to each other). The foundation of the bed 302 can include more than one zone that can be independently adjusted. The articulation controller can also provide different levels of massage to one or more users on the bed 302 or cause the bed to vibrate to communicate alerts to the user 308 as described above.

The control circuitry 334 can adjust positions (e.g., incline and decline positions for the user 308 and/or an additional user) in response to user interactions with the bed 302 (e.g., causing the articulation controller to adjust to a first recline position in response to sensing user bed presence). The control circuitry 334 can cause the articulation controller to adjust the bed 302 to a second recline position (e.g., a less reclined, or flat position) in response to determining that the user 308 is asleep. As another example, the control circuitry 334 can receive a communication from the television 312 indicating that the user 308 has turned off the television 312, and in response, the control circuitry 334 can cause the articulation controller to adjust the bed position to a preferred user sleeping position (e.g., due to the user turning off the television 312 while the user 308 is in bed indicating the user 308 wishes to go to sleep).

In some implementations, the control circuitry 334 can control the articulation controller to wake up one user without waking another user of the bed 302. For example, the user 308 and a second user can each set distinct wakeup times (e.g., 6:30 am and 7:15 am respectively). When the wakeup time for the user 308 is reached, the control circuitry 334 can cause the articulation controller to vibrate or change the position of only a side of the bed on which the user 308 is located. When the wakeup time for the second user is reached, the control circuitry 334 can cause the articulation controller to vibrate or change the position of only the side of the bed on which the second user is located. Alternatively, when the second wakeup time occurs, the control circuitry 334 can utilize other methods (such as audio alarms, or turning on the lights) to wake the second user since the user 308 is already awake and therefore will not be disturbed when the control circuitry 334 attempts to wake the second user.

Still referring to FIG. 3, the control circuitry 334 for the bed 302 can utilize information for interactions with the bed 302 by multiple users to generate control signals for controlling functions of various other devices. For example, the control circuitry 334 can wait to generate control signals for devices until both the user 308 and a second user are detected in the bed 302. The control circuitry 334 can generate a first set of control signals to cause the lighting system 314 to turn off a first set of lights upon detecting bed presence of the user 308 and generate a second set of control signals for turning off a second set of lights in response to detecting bed presence of a second user. The control circuitry 334 can also wait until it has been determined that both users are awake for the day before generating control signals to open the window blinds 330. One or more other home automation control signals can be determined and generated by the control circuitry 334, the user device 310, and/or the central controller.

Examples of Data Processing Systems Associated with a Bed

Described are example systems and components for data processing tasks that are, for example, associated with a bed. In some cases, multiple examples of a particular component or group of components are presented. Some examples are redundant and/or mutually exclusive alternatives. Connections between components are shown as examples to illustrate possible network configurations for allowing communication between components. Different formats of connections can be used as technically needed/desired. The connections generally indicate a logical connection that can be created with any technologically feasible format. For example, a network on a motherboard can be created with a printed circuit board, wireless data connections, and/or other types of network connections. Some logical connections are not shown for clarity (e.g., connections with power supplies and/or computer readable memory).

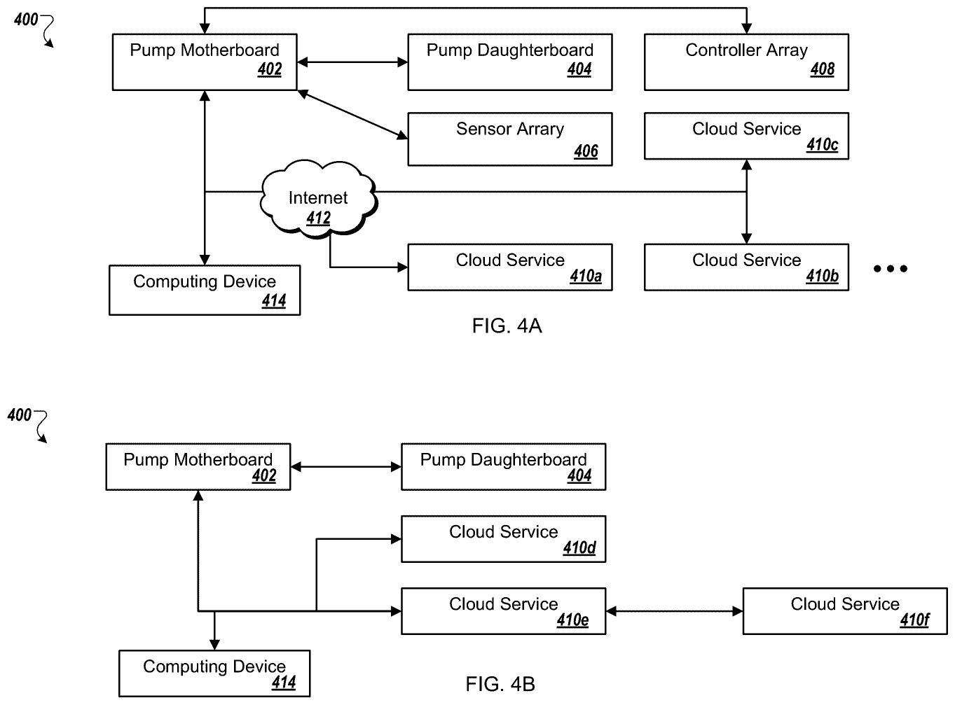

FIG. 4A is a block diagram of an example data processing system 400 that can be associated with a bed system, including those described above (e.g., see FIGS. 1-3). The system 400 includes a pump motherboard 402 and a pump daughterboard 404. The system 400 includes a sensor array 406 having one or more sensors configured to sense physical phenomenon of the environment and/or bed, and to report sensing back to the pump motherboard 402 (e.g., for analysis). The sensor array 406 can include one or more different types of sensors, including but not limited to pressure, temperature, light, movement (e.g. motion), and audio. The system 400 also includes a controller array 408 that can include one or more controllers configured to control logic-controlled devices of the bed and/or environment (e.g., home automation devices, security systems light systems, and other devices described in FIG. 3). The pump motherboard 400 can be in communication with computing devices 414 and cloud services 410 over local networks (e.g., Internet 412) or otherwise as is technically appropriate.

In FIG. 4A, the pump motherboard 402 and daughterboard 404 are communicably coupled. They can be conceptually described as a center or hub of the system 400, with the other components conceptually described as spokes of the system 400. This can mean that each spoke component communicates primarily or exclusively with the pump motherboard 402. For example, a sensor of the sensor array 406 may not be configured to, or may not be able to, communicate directly with a corresponding controller. Instead, the sensor can report a sensor reading to the motherboard 402, and the motherboard 402 can determine that, in response, a controller of the controller array 408 should adjust some parameters of a logic controlled device or otherwise modify a state of one or more peripheral devices.

One advantage of a hub-and-spoke network configuration, or a star-shaped network, is a reduction in network traffic compared to, for example, a mesh network with dynamic routing. If a particular sensor generates a large, continuous stream of traffic, that traffic is transmitted over one spoke to the motherboard 402. The motherboard 402 can marshal and condense that data to a smaller data format for retransmission for storage in a cloud service 410. Additionally or alternatively, the motherboard 402 can generate a single, small, command message to be sent down a different spoke in response to the large stream. For example, if the large stream of data is a pressure reading transmitted from the sensor array 406 a few times a second, the motherboard 402 can respond with a single command message to the controller array 408 to increase the pressure in an air chamber of the bed. In this case, the single command message can be orders of magnitude smaller than the stream of pressure readings.

As another advantage, a hub-and-spoke network configuration can allow for an extensible network that accommodates components being added, removed, failing, etc. This can allow more, fewer, or different sensors in the sensor array 406, controllers in the controller array 408, computing devices 414, and/or cloud services 410. For example, if a particular sensor fails or is deprecated by a newer version, the system 400 can be configured such that only the motherboard 402 needs to be updated about the replacement sensor. This can allow product differentiation where the same motherboard 402 can support an entry level product with fewer sensors and controllers, a higher value product with more sensors and controllers, and customer personalization where a customer can add their own selected components to the system 400.

Additionally, a line of air bed products can use the system 400 with different components. In an application in which every air bed in the product line includes both a central logic unit and a pump, the motherboard 402 (and optionally the daughterboard 404) can be designed to fit within a single, universal housing. For each upgrade of the product in the product line, additional sensors, controllers, cloud services, etc., can be added. Design, manufacturing, and testing time can be reduced by designing all products in a product line from this base, compared to a product line in which each product has a bespoke logic control system.

Each of the components discussed above can be realized in a wide variety of technologies and configurations. Below, some examples of each component are discussed. Sometimes, two or more components of the system 400 can be realized in a single alternative component; some components can be realized in multiple, separate components; and/or some functionality can be provided by different components.

FIG. 4B is a block diagram showing communication paths of the system 400. As described, the motherboard 402 and daughterboard 404 may act as a hub of the system 400. When the pump daughterboard 404 communicates with cloud services 410 or other components, communications may be routed through the motherboard 402. This may allow the bed to have a single connection with the Internet 412. The computing device 414 may also have a connection to the Internet 412, possibly through the same gateway used by the bed and/or a different gateway (e.g., a cell service provider).

In FIG. 4B, cloud services 410d and 410e may be configured such that the motherboard 402 communicates with the cloud service directly (e.g., without having to use another cloud service 410 as an intermediary). Additionally or alternatively, some cloud services 410 (e.g., 410f) may only be reachable by the motherboard 402 through an intermediary cloud service (e.g., 410c). While not shown here, some cloud services 410 may be reachable either directly or indirectly by the pump motherboard 402.

Additionally, some or all of the cloud services 410 may communicate with other cloud services, including the transfer of data and/or remote function calls according to any technologically appropriate format. For example, one cloud service 410 may request a copy for another cloud service's 410 data (e.g., for purposes of backup, coordination, migration, calculations, data mining). Many cloud services 410 may also contain data that is indexed according to specific users tracked by the user account cloud 410c and/or the bed data cloud 410a. These cloud services 410 may communicate with the user account cloud 410c and/or the bed data cloud 410a when accessing data specific to a particular user or bed.

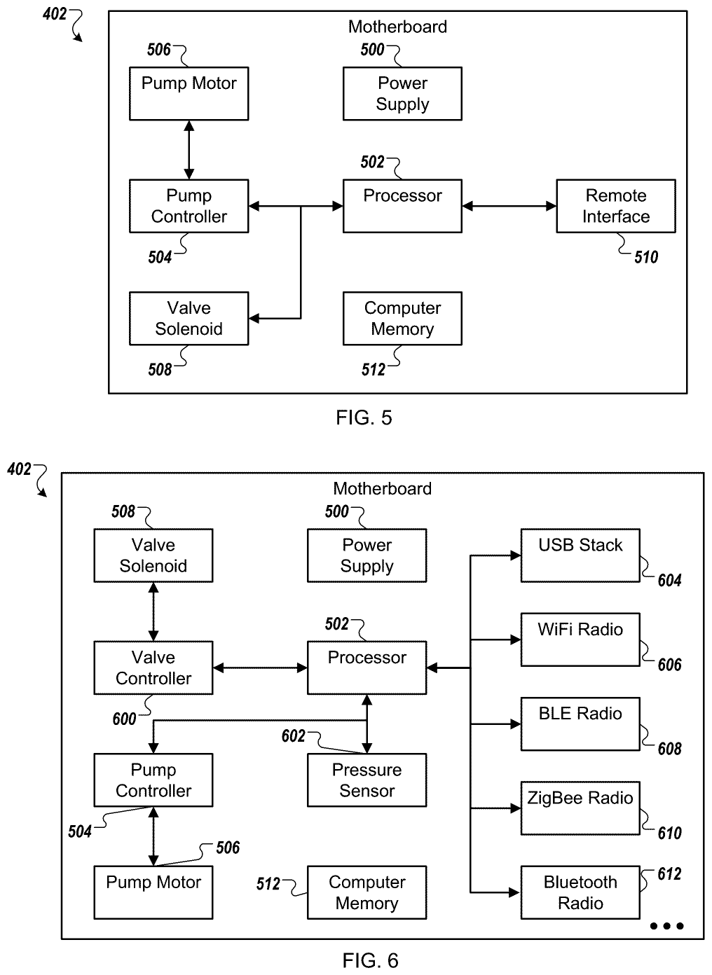

FIG. 5 is a block diagram of an example motherboard 402 in a data processing system associated with a bed system (e.g., refer to FIGS. 1-3). In this example, compared to other examples described below, this motherboard 402 consists of relatively fewer parts and can be limited to provide a relatively limited feature set.

The motherboard 402 includes a power supply 500, a processor 502, and computer memory 512. In general, the power supply 500 includes hardware used to receive electrical power from an outside source and supply it to components of the motherboard 402. The power supply may include a battery pack and/or wall outlet adapter, an AC to DC converter, a DC to AC converter, a power conditioner, a capacitor bank, and/or one or more interfaces for providing power in the current type, voltage, etc., needed by other components of the motherboard 402.

The processor 502 is generally a device for receiving input, performing logical determinations, and providing output. The processor 502 can be a central processing unit, a microprocessor, general purpose logic circuitry, application-specific integrated circuitry, a combination of these, and/or other hardware.

The memory 512 is generally one or more devices for storing data, which may include long term stable data storage (e.g., on a hard disk), short term unstable (e.g., on Random Access Memory), or any other technologically appropriate configuration.

The motherboard 402 includes a pump controller 504 and a pump motor 506. The pump controller 504 can receive commands from the processor 502 to control functioning of the pump motor 506. For example, the pump controller 504 can receive a command to increase pressure of an air chamber by 0.3 pounds per square inch (PSI). The pump controller 504, in response, engages a valve so that the pump motor 506 pumps air into the selected air chamber, and can engage the pump motor 506 for a length of time that corresponds to 0.3 PSI or until a sensor indicates that pressure has been increased by 0.3 PSI. Sometimes, the message can specify that the chamber should be inflated to a target PSI, and the pump controller 504 can engage the pump motor 506 until the target PSI is reached.

A valve solenoid 508 can control which air chamber a pump is connected to. In some cases, the solenoid 508 can be controlled by the processor 502 directly. In some cases, the solenoid 508 can be controlled by the pump controller 504.

A remote interface 510 of the motherboard 402 can allow the motherboard 402 to communicate with other components of a data processing system. For example, the motherboard 402 can be able to communicate with one or more daughterboards, with peripheral sensors, and/or with peripheral controllers through the remote interface 510. The remote interface 510 can provide any technologically appropriate communication interface, including but not limited to multiple communication interfaces such as WIFI, Bluetooth, and copper wired networks.

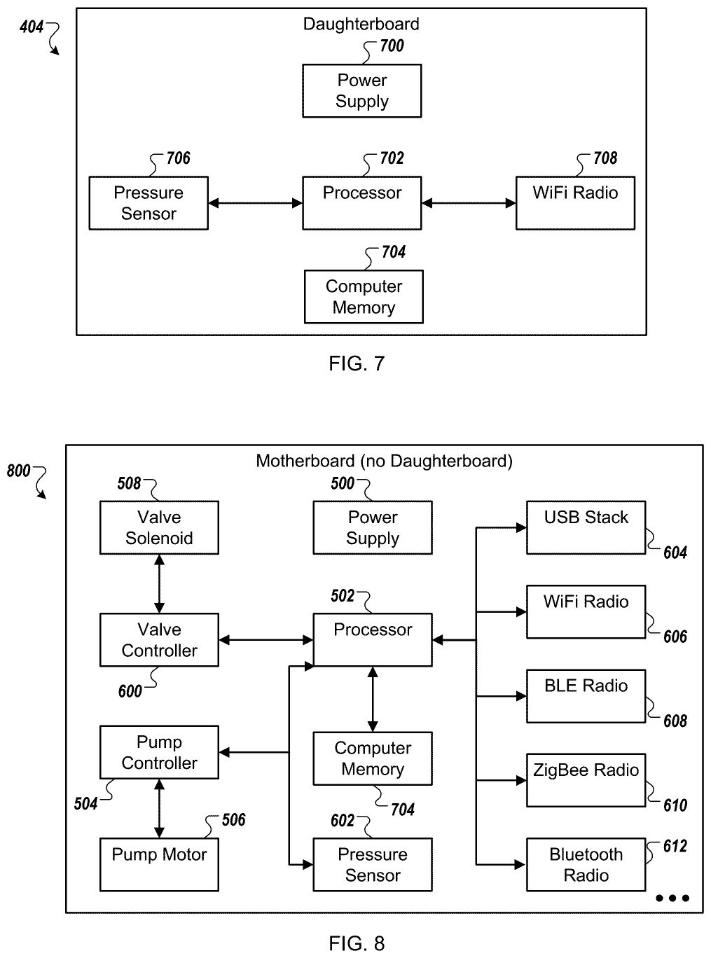

FIG. 6 is a block diagram of another example motherboard 402. Compared to the motherboard 402 in FIG. 5, the motherboard 402 in FIG. 6 can contain more components and provide more functionality in some applications.

This motherboard 402 can further include a valve controller 600, a pressure sensor 602, a universal serial bus (USB) stack 604, a WiFi radio 606, a Bluetooth Low Energy (BLE) radio 608, a ZigBee radio 610, a Bluetooth radio 612, and a computer memory 512.

The valve controller 600 can convert commands from the processor 502 into control signals for the valve solenoid 508. For example, the processor 502 can issue a command to the valve controller 600 to connect the pump to a particular air chamber out of a group of air chambers in an air bed. The valve controller 600 can control the position of the valve solenoid 508 so the pump is connected to the indicated air chamber.

The pressure sensor 602 can read pressure readings from one or more air chambers of the air bed. The pressure sensor 602 can also preform digital sensor conditioning. As described herein, multiple pressure sensors 602 can be included as part of the motherboard 402 or otherwise in communication with the motherboard 402.

The motherboard 402 can include a suite of network interfaces 604, 606, 608, 610, 612, etc., including but not limited to those shown in FIG. 6. These network interfaces can allow the motherboard to communicate over a wired or wireless network with any devices, including but not limited to peripheral sensors, peripheral controllers, computing devices, and devices and services connected to the Internet 412.

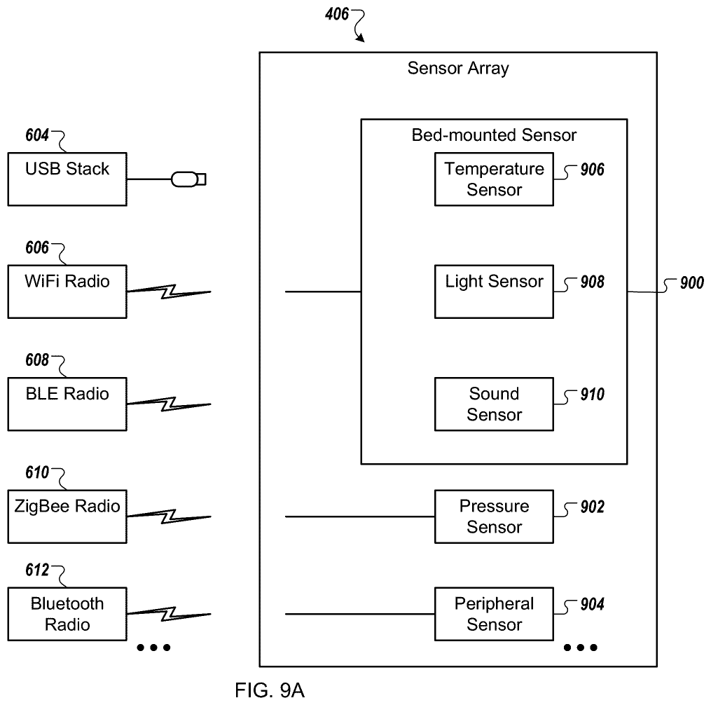

FIG. 7 is a block diagram of an example daughterboard 404 used in a data processing system associated with a bed system described herein. One or more daughterboards 404 can be connected to the motherboard 402. Some daughterboards 404 can be designed to offload particular and/or compartmentalized tasks from the motherboard 402. This can be advantageous if the particular tasks are computationally intensive, proprietary, or subject to future revisions. For example, the daughterboard 404 can be used to calculate a particular sleep data metric. This metric can be computationally intensive, and calculating the metric on the daughterboard 404 can free up resources of the motherboard 402 while the metric is calculated. The sleep metric may be subject to future revisions. To update the system 400 with the new metric, it is possible that only the daughterboard 404 calculates the metric to be replaced. In this case, the same motherboard 402 and other components can be used, saving the need to perform unit testing of additional components instead of just the daughterboard 404.

The daughterboard 404 includes a power supply 700, a processor 702, computer readable memory 704, a pressure sensor 706, and a WiFi radio 708. The processor 702 can use the pressure sensor 706 to gather information about pressure of air bed chambers. The processor 702 can perform an algorithm to calculate a sleep metric (e.g., sleep quality, bed presence, whether the user fell asleep, a heartrate, a respiration rate, movement, etc.). Sometimes, the sleep metric can be calculated from only air chamber pressure. The sleep metric can also be calculated using signals from a variety of sensors (e.g., movement, pressure, temperature, and/or audio sensors). The processor 702 can receive that data from sensors that may be internal to the daughterboard 404, accessible via the WiFi radio 708, or otherwise in communication with the processor 702. Once the sleep metric is calculated, the processor 702 can report that sleep metric to, for example, the motherboard 402. The motherboard 402 can generate instructions for outputting the sleep metric to the user or using the sleep metric to determine other user information or controls to control the bed and/or peripheral devices.

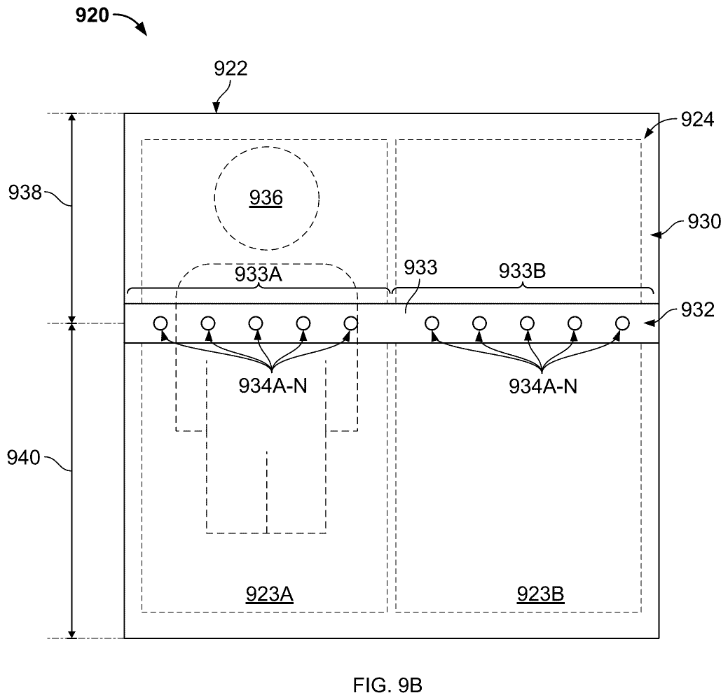

FIG. 8 is a block diagram of an example motherboard 800 with no daughterboard used in a data processing system associated with a bed system. In this example, the motherboard 800 can perform most, all, or more of the features described with reference to the motherboard 402 in FIG. 6 and the daughterboard 404 in FIG. 7.

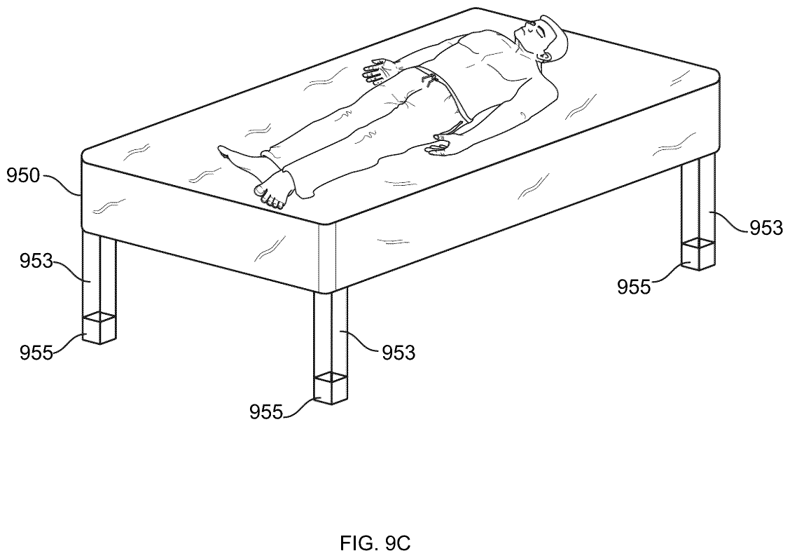

FIG. 9A is a block diagram of an example sensory array 406 used in a data processing system associated with a bed system described herein. The sensor array 406 is a conceptual grouping of some or all peripheral sensors that communicate with the motherboard 402 but are not native to the motherboard 402. The peripheral sensors 902, 904, 906, 908, 910, etc. of the sensor array 406 communicate with the motherboard 402 through one or more network interfaces 604, 606, 608, 610, and 612 of the motherboard, as is appropriate for the configuration of the particular sensor. For example, a sensor that outputs a reading over a USB cable can communicate through the USB stack 604.

Some peripheral sensors of the sensor array 406 can be bed mounted sensors 900 (e.g., temperature sensor 906, light sensor 908, sound sensor 910). The bed mounted sensors 900 can be embedded into a bed structure and sold with the bed, or later affixed to the structure (e.g., part of a pressure sensing pad that is removably installed on a top surface of the bed, part of a temperature sensing or heating pad that is removably installed on the top surface of the bed, integrated into the top surface, attached along connecting tubes between a pump and air chambers, within air chambers, attached to a headboard, attached to one or more regions of an adjustable foundation). One or more of the sensors 902 can be load cells or force sensors as described in FIG. 9C. Other sensors 902 and 904 may not be mounted to the bed and can include a pressure sensor 902 and/or peripheral sensor 904. For example, the sensors 902 and 904 can be integrated or otherwise part of a user mobile device (e.g., mobile phone, wearable device). The sensors 902 and 904 can also be part of a central controller for controlling the bed and peripheral devices. Sometimes, the sensors 902 and 904 can be part of one or more home automation devices or other peripheral devices.

Sometimes, some or all of the bed mounted sensors 900 and/or sensors 902 and 904 share networking hardware (e.g., a conduit that contains wires from each sensor, a multi-wire cable or plug that, when affixed to the motherboard 402, connect all the associated sensors with the motherboard 402). One, some, or all the sensors 902, 904, 906, 908, and 910 can sense features of a mattress (e.g., pressure, temperature, light, sound, and/or other features) and features external to the mattress. Sometimes, pressure sensor 902 can sense pressure of the mattress while some or all the sensors 902, 904, 906, 908, and 910 sense features of the mattress and/or features external to the mattress.

FIG. 9B is a schematic top view of a bed 920 having a sensor strip 932 with sensors 934A-N used in a data processing system associated with the bed 920. The bed 920 includes a mattress 922 (e.g., refer to FIG. 1). The mattress 922 can have a foam tub 930 beneath a top of the mattress 922. The foam tub 930 can have air chamber 923A and/or 923B, similar to those described herein.

The sensor strip 932 can be attached across the mattress top 924 from one lateral side to an opposing lateral side (e.g., from left to right). The sensor strip 932 can be attached proximate to a head section of the mattress 922 to measure temperature and/or humidity values around a chest area of a user 936. The sensor strip 932 can also be placed at a center point (e.g., midpoint) of the mattress 922 such that the distances 938 and 940 are equal to each other. The sensor strip 932 can be placed at other locations to capture temperature and/or humidity values at the top of the mattress 922.

The sensors 934A-N can be any one or more of the temperature sensors 906 described in FIG. 9A. The sensor strip 932 can also include a carrier strip 933 having a first strip portion 933A and a second strip portion 933B. The carrier strip 933 can be releasably attached to the foam tub layer 920 and extend between the opposite lateral ends of the foam tub 920. The sensor strip 932 can have first sensors 934A-N and second sensors 934A-N. Each of the first and second sensors 934A-N can have five sensors each. For example, a sensor strip 932 for a king or queen size mattress can have a total of ten sensors. When the user 936 is positioned on top of the mattress 922 over the air chamber 923A, the first sensors 934A-N can measure temperature and/or humidity of the mattress top 924 above the air chamber 923A. Those values can be used to, for example, determine a conditioned airflow to supply to the air chamber 923A. Temperature and/or humidity values measured by the second sensors 934A-N can be used to, for example, determine a conditioned airflow to supply to the air chamber 923B. The bed system 920 can provide for custom airflow to different portions of the mattress 922 based on body temperatures of users and/or temperatures of different portions of the mattress top 924.

Sometimes, two separate sensor strips can be attached to the mattress 922 (e.g., a first sensor strip over the air chamber 923A and a second sensor strip, separate from the first sensor strip, over the air chamber 923B). The first and second sensor strips can be attached to a center of the mattress top 924 via fastening elements, such as adhesive. The sensor strip 932 can also be easily replaced with another sensor strip.

FIG. 9C is a schematic diagram of an example bed with force sensors 955 located at the bottom of legs 953 of the bed (e.g., in four, six, eight, or another number of legs). The force sensors 955 may also be located elsewhere on the bed with similar effect (e.g., between the legs 953 and platform 950). When a strain gauge is used as the force sensors 955, the force sensor(s) 955 can be positioned nearer centers of the legs 953. The force sensors 955 can be load cells.

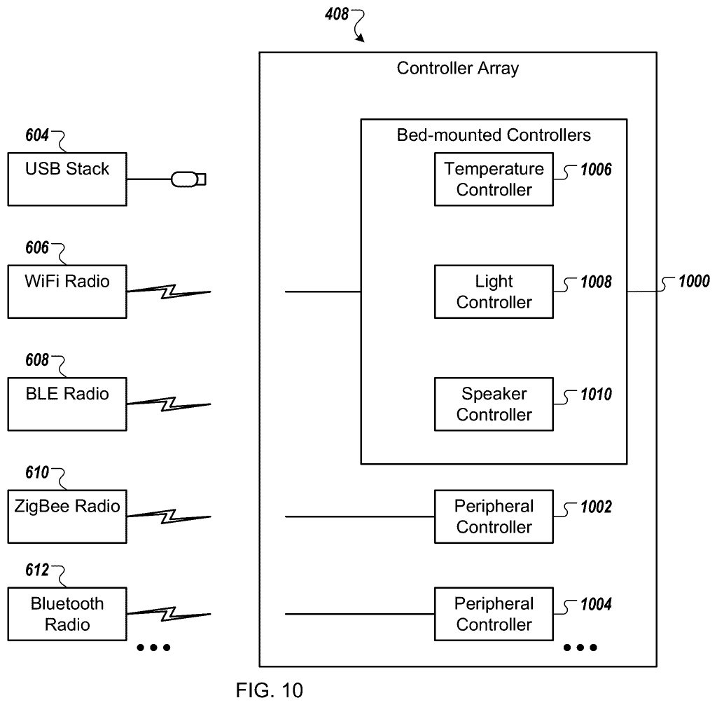

FIG. 10 is a block diagram of an example controller array 408 used in a data processing system associated with a bed system. The controller array 408 is a conceptual grouping of some or all peripheral controllers that communicate with the motherboard 402 but are not native to the motherboard 402. The peripheral controllers can communicate with the motherboard 402 through one or more of the network interfaces 604, 606, 608, 610, and 612 of the motherboard, as is appropriate for the configuration of the particular controller. Some of the controllers can be bed mounted controllers 1000, such as a temperature controller 1006, a light controller 1008, and a speaker controller 1010, as described in reference to bed-mounted sensors in FIG. 9A. Peripheral controllers 1002 and 1004 can be in communication with the motherboard 402, but optionally not mounted to the bed.

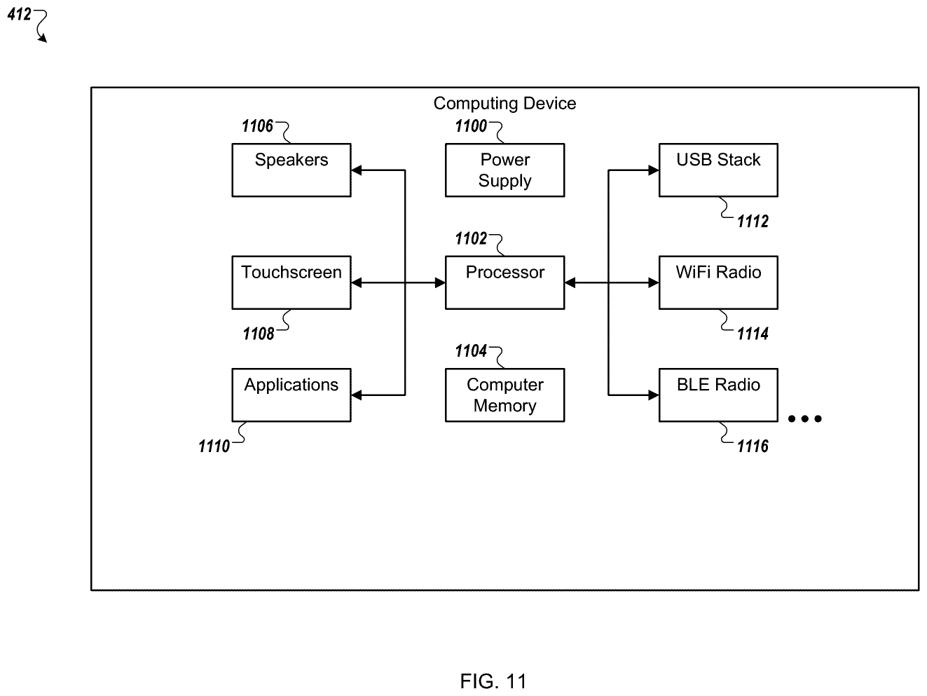

FIG. 11 is a block diagram of an example computing device 412 used in a data processing system associated with a bed system. The computing device 412 can include computing devices used by a user of a bed including but not limited to mobile computing devices (e.g., mobile phones, tablet computers, laptops, smart phones, wearable devices), desktop computers, home automation devices, and/or central controllers or other hub devices.

The computing device 412 includes a power supply 1100, a processor 1102, and computer readable memory 1104. User input and output can be transmitted by speakers 1106, a touchscreen 1108, or other not shown components (e.g., a pointing device or keyboard). The computing device 412 can run applications 1110 including, for example, applications to allow the user to interact with the system 400. These applications can allow a user to view information about the bed (e.g., sensor readings, sleep metrics), information about themselves (e.g., health conditions detected based on signals sensed at the bed), and/or configure the system 400 behavior (e.g., set desired firmness, set desired behavior for peripheral devices). The computing device 412 can be used in addition to, or to replace, the remote control 122 described above.

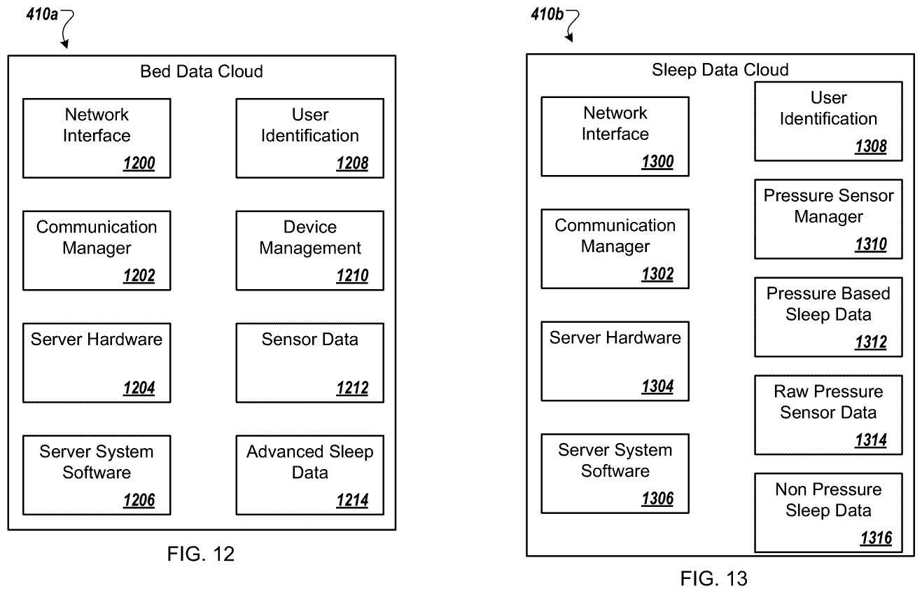

FIG. 12 is a block diagram of an example bed data cloud service 410a used in a data processing system associated with a bed system. Here, the bed data cloud service 410a is configured to collect sensor data and sleep data from a particular bed, and to match the data with one or more users that used the bed when the data was generated.

The bed data cloud service 410a includes a network interface 1200, a communication manager 1202, server hardware 1204, and server system software 1206. The bed data cloud service 410a is also shown with a user identification module 1208, a device management 1210 module, a sensor data module 1210, and an advanced sleep data module 1214. The network interface 1200 includes hardware and low level software to allow hardware devices (e.g., components of the service 410a) to communicate over networks (e.g., with each other, with other destinations over the Internet 412). The network interface 1200 can include network cards, routers, modems, and other hardware. The communication manager 1202 generally includes hardware and software that operate above the network interface 1200 such as software to initiate, maintain, and tear down network communications used by the service 410a (e.g., TCP/IP, SSL or TLS, Torrent, and other communication sessions over local or wide area networks). The communication manager 1202 can also provide load balancing and other services to other elements of the service 410a. The server hardware 1204 generally includes physical processing devices used to instantiate and maintain the service 410a. This hardware includes, but is not limited to, processors (e.g., central processing units, ASICs, graphical processers) and computer readable memory (e.g., random access memory, stable hard disks, tape backup). One or more servers can be configured into clusters, multi-computer, or datacenters that can be geographically separate or connected. The server system software 1206 generally includes software that runs on the server hardware 1204 to provide operating environments to applications and services (e.g., operating systems running on real servers, virtual machines instantiated on real servers to create many virtual servers, server level operations such as data migration, redundancy, and backup).

The user identification 1208 can include, or reference, data related to users of beds with associated data processing systems. The users may include customers, owners, or other users registered with the service 410a or another service. Each user can have a unique identifier, user credentials, contact information, billing information, demographic information, or any other technologically appropriate information.

The device manager 1210 can include, or reference, data related to beds or other products associated with data processing systems. The beds can include products sold or registered with a system associated with the service 410a. Each bed can have a unique identifier, model and/or serial number, sales information, geographic information, delivery information, a listing of associated sensors and control peripherals, etc. An index or indexes stored by the service 410a can identify users associated with beds. This index can record sales of a bed to a user, users that sleep in a bed, etc.

The sensor data 1212 can record raw or condensed sensor data recorded by beds with associated data processing systems. For example, a bed's data processing system can have temperature, pressure, motion, audio, and/or light sensors. Readings from these sensors, either in raw form or in a format generated from the raw data (e.g. sleep metrics), can be communicated by the bed's data processing system to the service 410a for storage in the sensor data 1212. An index or indexes stored by the service 410a can identify users and/or beds associated with the sensor data 1212.

The service 410a can use any of its available data (e.g., sensor data 1212) to generate advanced sleep data 1214. The advanced sleep data 1214 includes sleep metrics and other data generated from sensor readings (e.g., health information). Some of these calculations can be performed in the service 410a instead of locally on the bed's data processing system because the calculations can be computationally complex or require a large amount of memory space or processor power that may not be available on the bed's data processing system. This can help allow a bed system to operate with a relatively simple controller while being part of a system that performs relatively complex tasks and computations.

For example, the service 410a can retrieve one or more machine learning models from a remote data store and use those models to determine the advanced sleep data 1214. The service 410a can retrieve one or more models to determine overall sleep quality of the user based on currently detected sensor data 1212 and/or historic sensor data. The service 410a can retrieve other models to determine whether the user is snoring based on the detected sensor data 1212. The service 410a can retrieve other models to determine whether the user experiences a health condition based on the data 1212.

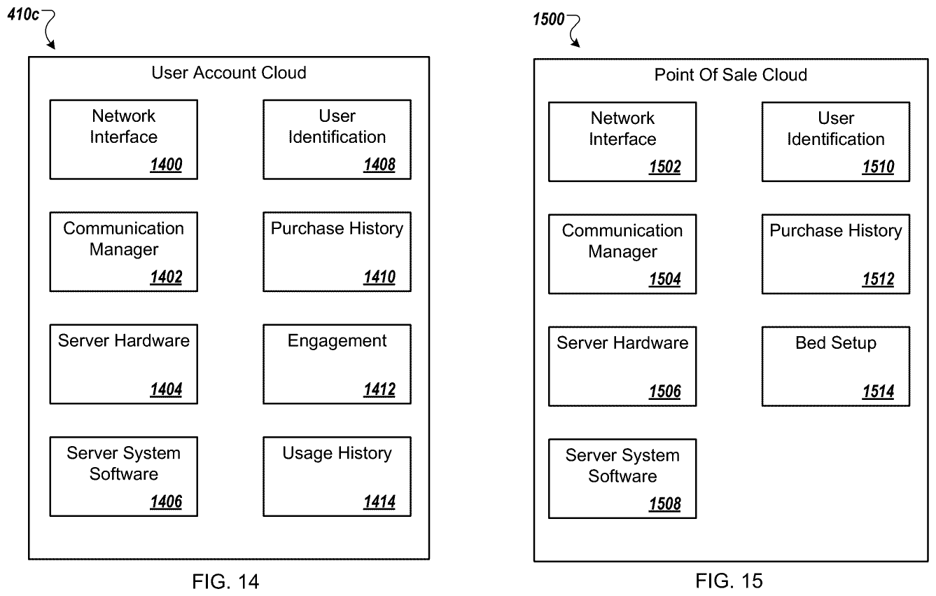

FIG. 13 is a block diagram of an example sleep data cloud service 410b used in a data processing system associated with a bed system. Here, the sleep data cloud service 410b is configured to record data related to users' sleep experience. The service 410b includes a network interface 1300, a communication manager 1302, server hardware 1304, and server system software 1306. The service 410b also includes a user identification module 1308, a pressure sensor manager 1310, a pressure based sleep data module 1312, a raw pressure sensor data module 1314, and a non-pressure sleep data module 1316. Sometimes, the service 410b can include a sensor manager for each sensor. The service 410b can also include a sensor manager that relates to multiple sensors in beds (e.g., a single sensor manager can relate to pressure, temperature, light, movement, and audio sensors in a bed).

The pressure sensor manager 1310 can include, or reference, data related to the configuration and operation of pressure sensors in beds. This data can include an identifier of the types of sensors in a particular bed, their settings and calibration data, etc. The pressure based sleep data 1312 can use raw pressure sensor data 1314 to calculate sleep metrics tied to pressure sensor data. For example, user presence, movements, weight change, heartrate, and breathing rate can be determined from raw pressure sensor data 1314. An index or indexes stored by the service 410b can identify users associated with pressure sensors, raw pressure sensor data, and/or pressure based sleep data. The non-pressure sleep data 1316 can use other sources of data to calculate sleep metrics. User-entered preferences, light sensor readings, and sound sensor readings can be used to track sleep data. User presence can also be determined from a combination of raw pressure sensor data 1314 and non-pressure sleep data 1316 (e.g., raw temperature data). Sometimes, bed presence can be determined using only the temperature data. Changes in temperature data can be monitored to determine bed presence or absence in a temporal interval (e.g., window of time) of a given duration. The temperature and/or pressure data can also be combined with other sensing modalities or motion sensors that reflect different forms of movement (e.g., load cells) to accurately detect user presence. For example, the temperature and/or pressure data can be provided as input to a bed presence classifier, which can determine user bed presence based on real-time or near real-time data collected at the bed. The classifier can be trained to differentiate the temperature data from the pressure data, identify peak values in the temperature and pressure data, and generate a bed presence indication based on correlating the peak values. The peak values can be within a threshold distance from each other to then generate an indication that the user is in the bed. An index or indexes stored by the service 410b can identify users associated with sensors and/or the data 1316.

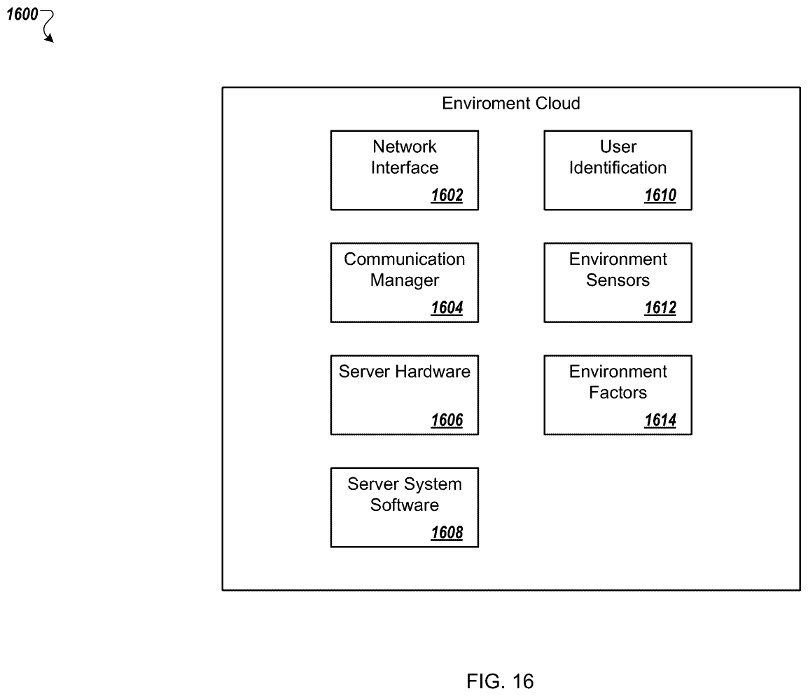

FIG. 14 is a block diagram of an example user account cloud service 410c used in a data processing system associated with a bed system. Here, the service 410c is configured to record a list of users and to identify other data related to those users. The service 410c includes a network interface 1400, a communication manager 1402, server hardware 1404, and server system software 1406. The service 410c also includes a user identification module 1408, a purchase history module 1410, an engagement module 1412, and an application usage history module 1414.

The user identification module 1408 can include, or reference, data related to users of beds with associated data processing systems, as described above. The purchase history module 1410 can include, or reference, data related to purchases by users. The purchase data can include a sale's contact information, billing information, and salesperson information associated with the user's purchase of the bed system. An index or indexes stored by the service 410c can identify users associated with a bed purchase.

The engagement module 1412 can track user interactions with the manufacturer, vendor, and/or manager of the bed/cloud services. This data can include communications (e.g., emails, service calls), data from sales (e.g., sales receipts, configuration logs), and social network interactions. The data can also include servicing, maintenance, or replacements of components of the user's bed system. The usage history module 1414 can contain data about user interactions with applications and/or remote controls of the bed. A monitoring and configuration application can be distributed to run on, for example, computing devices 412 described herein. The application can log and report user interactions for storage in the application usage history module 1414. An index or indexes stored by the service 410c can also identify users associated with each log entry. User interactions stored in the module 1414 can optionally be used to determine or predict user preferences and/or settings for the user's bed and/or peripheral devices that can improve the user's overall sleep quality.

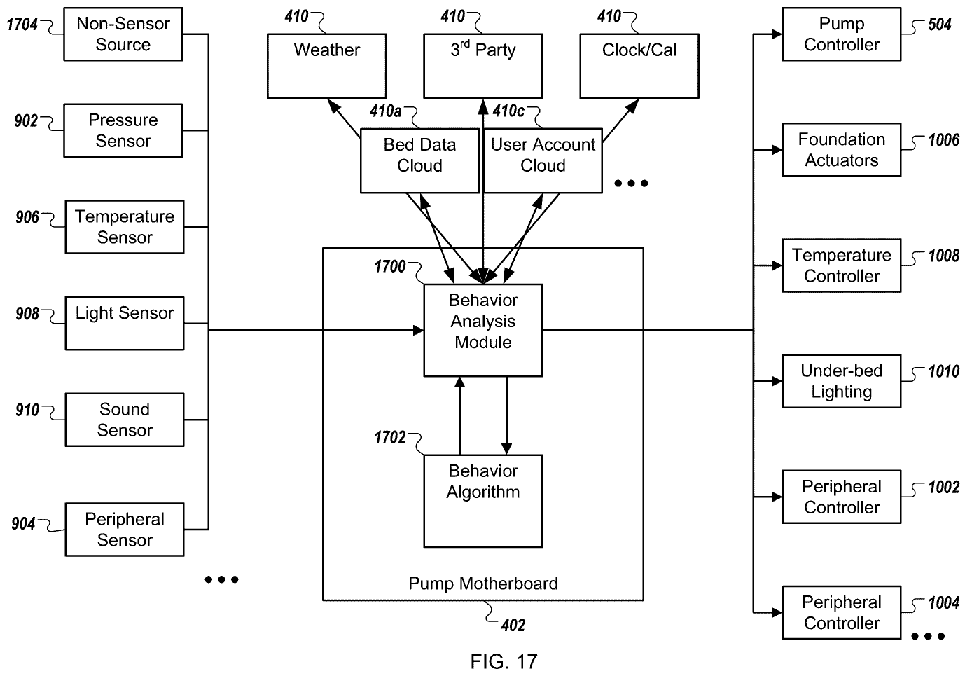

FIG. 15 is a block diagram of an example point of sale cloud service 1500 used in a data processing system associated with a bed system. Here, the service 1500 can record data related to users' purchases, specifically purchases of bed systems described herein. The service 1500 is shown with a network interface 1502, a communication manager 1504, server hardware 1506, and server system software 1508. The service 1500 also includes a user identification module 1510, a purchase history module 1512, and a bed setup module 1514.

The purchase history module 1512 can include, or reference, data related to purchases made by users identified in the module 1510, such as data of a sale, price, and location of sale, delivery address, and configuration options selected by the users at the time of sale. The configuration options can include selections made by the user about how they wish their newly purchased beds to be setup and can include expected sleep schedule, a listing of peripheral sensors and controllers that they have or will install, etc.

The bed setup module 1514 can include, or reference, data related to installations of beds that users purchase. The bed setup data can include a date and address to which a bed is delivered, a person who accepts delivery, configuration that is applied to the bed upon delivery (e.g., firmness settings), name(s) of bed user(s), which side of the bed each user will use, etc. Data recorded in the service 1500 can be referenced by a user's bed system at later times to control functionality of the bed system and/or to send control signals to peripheral components. This can allow a salesperson to collect information from the user at the point of sale that later facilitates bed system automation. Sometimes, some or all aspects of the bed system can be automated with little or no user-entered data required after the point of sale. Sometimes, data recorded in the service 1500 can be used in connection with other, user-entered data.

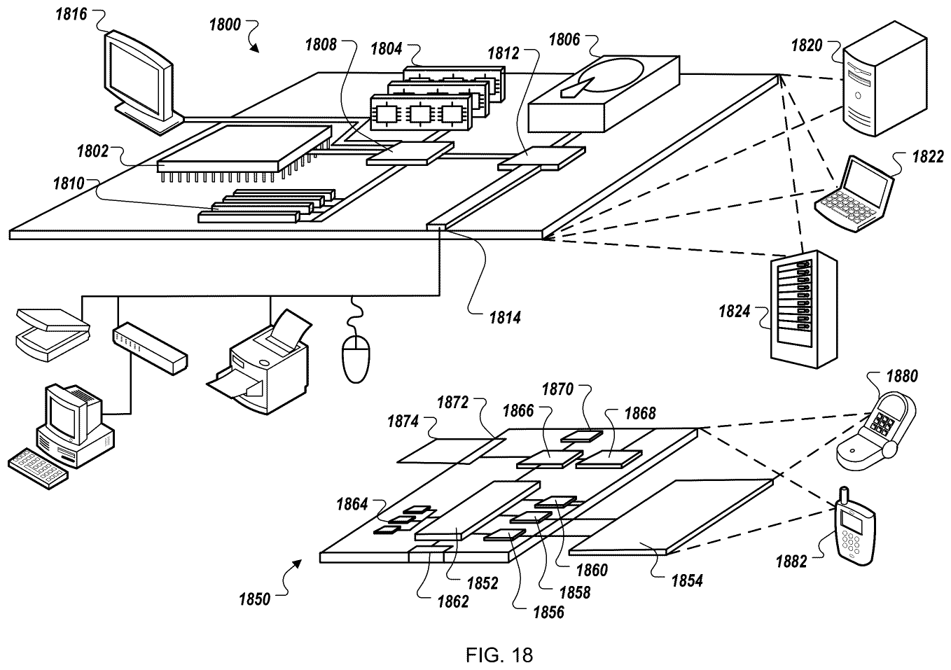

FIG. 16 is a block diagram of an example environment cloud service 1600 used in a data processing system associated with a bed system. Here, the service 1600 is configured to record data related to users' home environment. The service 1600 includes a network interface 1602, a communication manager 1604, server hardware 1606, and server system software 1608. The service 1600 also includes a user identification module 1610, an environmental sensors module 1612, and an environmental factors module 1614. The environmental sensors module 1612 can include a listing and identification of sensors that users identified in the module 1610 to have installed in and/or surrounding their bed (e.g., light, noise/audio, vibration, thermostats, movement/motion sensors). The module 1612 can also store historical readings or reports from the environmental sensors. The module 1612 can be accessed at a later time and used by one or more cloud services described herein to determine sleep quality and/or health information of the users. The environmental factors module 1614 can include reports generated based on data in the module 1612. For example, the module 1614 can generate and retain a report indicating frequency and duration of instances of increased lighting when the user is asleep based on light sensor data that is stored in the environment sensors module 1612.

In the examples discussed here, each cloud service 410 is shown with some of the same components. These same components can be partially or wholly shared between services, or they can be separate. Sometimes, each service can have separate copies of some or all the components that are the same or different in some ways. These components are provided as illustrative examples. In other examples, each cloud service can have different number, types, and styles of components that are technically possible.

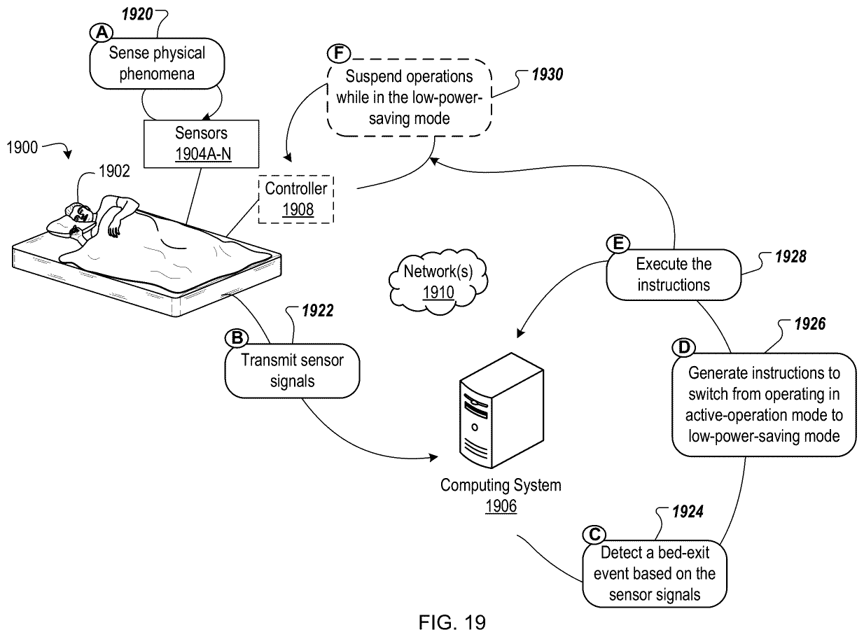

FIG. 17 is a block diagram of an example of using a data processing system associated with a bed to automate peripherals around the bed. Shown here is a behavior analysis module 1700 that runs on the motherboard 402. The behavior analysis module 1700 can be one or more software components stored on the computer memory 512 and executed by the processor 502. In general, the module 1700 can collect data from a variety of sources (e.g., sensors 902, 904, 906, 908, and/or 910, non-sensor local sources 1704, cloud data services 410a and/or 410c) and use a behavioral algorithm 1702 (e.g., machine learning model(s)) to generate actions to be taken (e.g., commands to send to peripheral controllers, data to send to cloud services, such as the bed data cloud 410a and/or the user account cloud 410c). This can be useful, for example, in tracking user behavior and automating devices in communication with the user's bed.

The module 1700 can collect data from any technologically appropriate source (e.g., sensors of the sensor array 406) to gather data about features of a bed, the bed's environment, and/or the bed's users. The data can provide the module 1700 with information about a current state of the bed's environment. For example, the module 1700 can access readings from the pressure sensor 902 to determine air chamber pressure in the bed. From this reading, and potentially other data, user presence can be determined. In another example, the module 1700 can access the light sensor 908 to detect the amount of light in the environment. The module 1700 can also access the temperature sensor 906 to detect a temperature in the environment and/or microclimates in the bed. Using this data, the module 1700 can determine whether temperature adjustments should be made to the environment and/or components of the bed to improve the user's sleep quality and overall comfortability. Similarly, the module 1700 can access data from cloud services to make more accurate determinations of user sleep quality, health information, and/or control the bed and/or peripheral devices. For example, the behavior analysis module 1700 can access the bed cloud service 410a to access historical sensor data 1212 and/or advanced sleep data 1214. The module 1700 can also access a weather reporting service, a 3rd party data provider (e.g., traffic and news data, emergency broadcast data, user travel data), and/or a clock and calendar service. Using data retrieved from the cloud services 410, the module 1700 can accurately determine user sleep quality, health information, and/or control of the bed and/or peripheral devices. Similarly, the module 1700 can access data from non-sensor sources 1704, such as a local clock and calendar service (e.g., a component of the motherboard 402 or of the processor 502). The module 1700 can use this information to determine, for example, times of day that the user is in bed, asleep, waking up, and/or going to bed.

The behavior analysis module 1700 can aggregate and prepare this data for use with one or more behavioral algorithms 1702 (e.g., machine learning models). The behavioral algorithms 1702 can be used to learn a user's behavior and/or to perform some action based on the state of the accessed data and/or the predicted user behavior. For example, the behavior algorithm 1702 can use available data (e.g., pressure sensor, non-sensor data, clock and calendar data) to create a model of when a user goes to bed every night. Later, the same or a different behavioral algorithm 1702 can be used to determine if an increase in air chamber pressure is likely to indicate a user going to bed and, if so, send some data to a third-party cloud service 410 and/or engage a peripheral controller 1002 or 1004, foundation actuators 1006, a temperature controller 1008, and/or an under-bed lighting controller 1010.

Here, the module 1700 and the behavioral algorithm 1702 are shown as components of the motherboard 402. Other configurations are also possible. For example, the same or a similar behavioral analysis module 1700 and/or behavioral algorithm 1702 can be run in one or more cloud services, and resulting output can be sent to the pump motherboard 402, a controller in the controller array 408, or to any other technologically appropriate recipient described throughout this document.

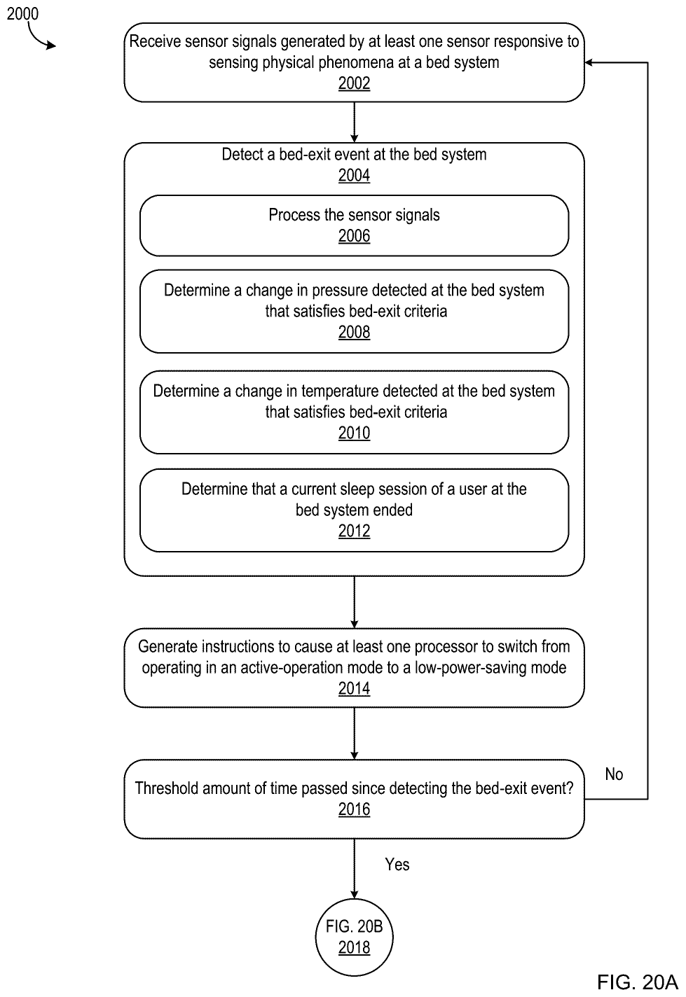

FIG. 18 shows an example of a computing device 1800 and an example of a mobile computing device that can be used to implement the techniques described here. The computing device 1800 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 1800 includes a processor 1802, a memory 1804, a storage device 1806, a high-speed interface 1808 connecting to the memory 1804 and multiple high-speed expansion ports 1810, and a low-speed interface 1812 connecting to a low-speed expansion port 1814 and the storage device 1806. Each of the processor 1802, the memory 1804, the storage device 1806, the high-speed interface 1808, the high-speed expansion ports 1810, and the low-speed interface 1812, are interconnected using various busses, and can be mounted on a common motherboard or in other manners as appropriate. The processor 1802 can process instructions for execution within the computing device 1800, including instructions stored in the memory 1804 or on the storage device 1806 to display graphical information for a GUI on an external input/output device, such as a display 1816 coupled to the high-speed interface 1808. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system). The memory 1804 stores information within the computing device 1800. In some implementations, the memory 1804 is a volatile memory unit or units. In some implementations, the memory 1804 is a non-volatile memory unit or units. The memory 1804 can also be another form of computer-readable medium, such as a magnetic or optical disk. The storage device 1806 is capable of providing mass storage for the computing device 1800. In some implementations, the storage device 1806 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The computer program product can also be tangibly embodied in a computer- or machine-readable medium, such as the memory 1804, the storage device 1806, or memory on the processor 1802.

The high-speed interface 1808 manages bandwidth-intensive operations for the computing device 1800, while the low-speed interface 1812 manages lower bandwidth-intensive operations. Such allocation of functions is exemplary only. In some implementations, the high-speed interface 1808 is coupled to the memory 1804, the display 1816 (e.g., through a graphics processor or accelerator), and to the high-speed expansion ports 1810, which can accept various expansion cards (not shown). In the implementation, the low-speed interface 1812 is coupled to the storage device 1806 and the low-speed expansion port 1814. The low-speed expansion port 1814, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter. The computing device 1800 can be implemented in a number of different forms, as shown in the figure. For example, it can be implemented as a standard server 1820, or multiple times in a group of such servers. In addition, it can be implemented in a personal computer such as a laptop computer 1822. It can also be implemented as part of a rack server system 1824. Alternatively, components from the computing device 1800 can be combined with other components in a mobile device (not shown), such as a mobile computing device 1850. Each of such devices can contain one or more of the computing device 1800 and the mobile computing device 1850, and an entire system can be made up of multiple computing devices communicating with each other. The mobile computing device 1850 includes a processor 1852, a memory 1864, an input/output device such as a display 1854, a communication interface 1866, and a transceiver 1868, among other components. The mobile computing device 1850 can also be provided with a storage device, such as a micro-drive or other device, to provide additional storage. Each of the processor 1852, the memory 1864, the display 1854, the communication interface 1866, and the transceiver 1868, are interconnected using various buses, and several of the components can be mounted on a common motherboard or in other manners as appropriate.

The processor 1852 can execute instructions within the mobile computing device 1850, including instructions stored in the memory 1864. The processor 1852 can be implemented as a chipset of chips that include separate and multiple analog and digital processors. The processor 1852 can provide, for example, for coordination of the other components of the mobile computing device 1850, such as control of user interfaces, applications run by the mobile computing device 1850, and wireless communication by the mobile computing device 1850. The processor 1852 can communicate with a user through a control interface 1858 and a display interface 1856 coupled to the display 1854. The display 1854 can be, for example, a TFT (Thin-Film-Transistor Liquid Crystal Display) display or an OLED (Organic Light Emitting Diode) display, or other appropriate display technology. The display interface 1856 can comprise appropriate circuitry for driving the display 1854 to present graphical and other information to a user.

The control interface 1858 can receive commands from a user and convert them for submission to the processor 1852. In addition, an external interface 1862 can provide communication with the processor 1852, so as to enable near area communication of the mobile computing device 1850 with other devices. The external interface 1862 can provide, for example, for wired communication in some implementations, or for wireless communication in other implementations, and multiple interfaces can also be used.

The memory 1864 stores information within the mobile computing device 1850. The memory 1864 can be implemented as one or more of a computer-readable medium or media, a volatile memory unit or units, or a non-volatile memory unit or units. An expansion memory 1874 can also be provided and connected to the mobile computing device 1850 through an expansion interface 1872, which can include, for example, a SIMM (Single In Line Memory Module) card interface. The expansion memory 1874 can provide extra storage space for the mobile computing device 1850, or can also store applications or other information for the mobile computing device 1850. Specifically, the expansion memory 1874 can include instructions to carry out or supplement the processes described above, and can include secure information also. Thus, for example, the expansion memory 1874 can be provide as a security module for the mobile computing device 1850, and can be programmed with instructions that permit secure use of the mobile computing device 1850. In addition, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 1864, the expansion memory 1874, or memory on the processor 1852. In some implementations, the computer program product can be received in a propagated signal, for example, over the transceiver 1868 or the external interface 1862.

The mobile computing device 1850 can communicate wirelessly through the communication interface 1866, which can include digital signal processing circuitry where necessary. The communication interface 1866 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 1868 using a radio-frequency. In addition, short-range communication can occur, such as using a Bluetooth, WiFi, or other such transceiver (not shown). In addition, a GPS (Global Positioning System) receiver module 1870 can provide additional navigation- and location-related wireless data to the mobile computing device 1850, which can be used as appropriate by applications running on the mobile computing device 1850. The mobile computing device 1850 can also communicate audibly using an audio codec 1860, which can receive spoken information from a user and convert it to usable digital information. The audio codec 1860 can likewise generate audible sound for a user, such as through a speaker, e.g., in a handset of the mobile computing device 1850. Such sound can include sound from voice telephone calls, can include recorded sound (e.g., voice messages, music files, etc.) and can also include sound generated by applications operating on the mobile computing device 1850. The mobile computing device 1850 can be implemented in a number of different forms, as shown in the figure. For example, it can be implemented as a cellular telephone 1880. It can also be implemented as part of a smart-phone 1882, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input. The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet. The computing system can include clients and servers. A client and server are generally remote from each other and typically interact through a communication network. The relationship of client and server arises by virtue of computer programs running on the respective computers and having a client-server relationship to each other.

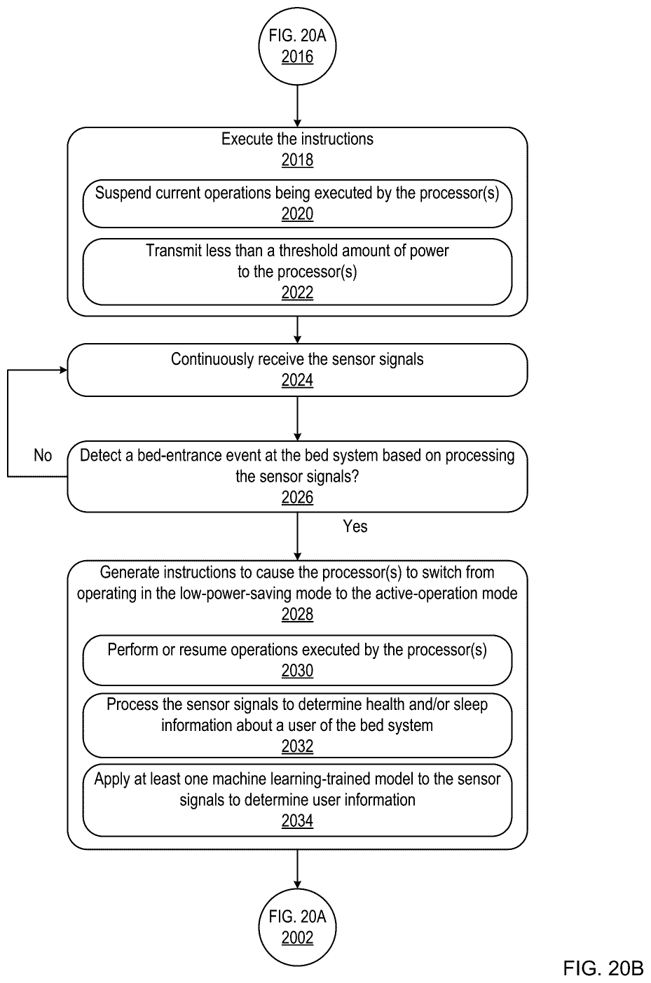

FIG. 19 is a conceptual diagram for switching bed system components between active-operation mode and low-power-saving mode. A user 1902 can sleep or otherwise use a bed system 1900. The bed system 1900 can be any of the bed systems described above in this disclosure. The bed system 1900 can include sensors 1904A-N and an optional controller 1908. The sensors 1904A-N can be any of the sensors described throughout this disclosure. As an illustrative example, the sensors 1904A-N can include at least one pressure sensor. Other sensors described herein are also possible. The controller 1908 can be any type of controller described throughout this disclosure. The controller 1908 can be configured to control operations of one or more components of the bed system 1900. The controller 1908 can, sometimes, be a pump of the bed system 1900. As another example, the controller 1908 can include one or more processors and can be configured to perform any of the operations described herein, such as detecting bed presence and bed exit events and/or determining user health and/or sleep metrics/information. In yet some implementations, the computing system 1906 can be a first processor and the controller 1908 can be a second processor.

The computing system 1906 (e.g., the first processor) can be configured to continuously operate and detect bed presence events while the controller 1908 (e.g., the second processor) can be configured to switch between operation modes based on the determinations made by the computing system 1906. More particularly, the computing system 1906 can generate instructions to switch modes of one or more processors. The one or more processors can be processors of the computing system 1906 and/or the controller 1908 (e.g. the second processor or multiple other processors). As a non-limiting illustrative example, the computing system 1906 can have a low-level processor that is configured to continuously operate in the active-operation mode to detect bed-exit and bed-entrance events. The controller 1908 of the bed system 1900 can have a different processor (or multiple processors) that requires more compute resources and/or processing power to operate than the processor of the computing system 1906. Therefore, using the disclosed techniques, the controller 1908 can switch between operating in the active-operation mode and the lower-power-saving mode based on the determination made at the computing system 1906 about detecting bed-exit events.

The sensors 1904A-N and the optional controller 1908 can be in communication (e.g., wired and/or wireless) with a computing system 1906 over network(s) 1910. The computing system 1906 can be configured to determine any of the operations described herein. The computing system 1906 can be any type of computer and/or network of computers and/or devices. The computing system 1906 can, in some implementations, be the controller 1908 of the bed system 1900. Therefore, the controller 1908 can perform the operations of the computer system 1906 that are described further below. The computing system 1906 can be remote from the bed system 1900. In some implementations, the computing system 1906 can be part of or otherwise integrated into the bed system 1900.

Still referring to FIG. 19 the sensors 1904A-N can sense physical phenomena at the bed system 1900 (block A, 1920). As described herein, the sensors 1904A-N can continuously sense the physical phenomena. The sensors 1904A-N can additionally or alternatively sense the physical phenomena at predetermined time intervals (e.g., every minute, every 5 minutes, every 10 minutes). The physical phenomena can include pressure signals, temperature signals, load cell signals, or other types of sensor signals and/or any other combination thereof described herein.

The sensors 1904A-N can transmit sensor signals indicating the sensed physical phenomena to the computing system 1906 (block B, 1922). The sensor signals can be transmitted in real-time, as the physical phenomena are detected by the sensors 1904A-N. The sensor signals can additionally or alternatively be transmitted in near real-time or at predetermined time intervals (e.g., every minute, every 5 minutes, every 10 minutes, every 15 minutes).

The computing system 1906 can detect a bed-exit event based on the sensor signals in block C (1924). Using any of the disclosed techniques, the computing system 1906 can determine whether the sensor signals are indicative of a bed-exit event. As an illustrative example, the sensor signals can be pressure sensor signals. The computing system 1906 can detect a change in pressure between pressure sensor signals received at a first time and pressure sensor signals received at a second time that is some amount of time after the first time. The computing system 1906 can determine whether the change in pressure meets a threshold change in pressure value indicative of the user 1902 getting up from the bed system 1900. Therefore, if the change in pressure meets the threshold value, then the user 1902 has exited the bed system 1900. The computing system 1906 can implement one or more machine learning algorithms, techniques, and/or models to detect the bed-exit event. In some implementations, the computing system 1906 can also determine whether the change in pressure lasts for at least a threshold amount of time. The threshold amount of time can be used to ensure that the user 1902 has actually exited the bed system 1900 and thus completed or otherwise ended a sleep session. If the change in pressure exists for less than the threshold amount of time, then the user 1902 might have simply gotten out of the bed system 1900 during their sleep session to get a glass of water and/or use the bathroom. Therefore, the user 1902 may return to the bed system 1900 to continue their current sleep session. The threshold amount of time can be one or more different times, that can be specific to prior sleep patterns of the user 1902 and/or generic to a population of users (the population may or may not include the user 1902). As non-limiting examples, the threshold amount of time can include, but is not limited to, 5 minutes, 10 minutes, 15 minutes, 20 minutes, 25 minutes, 30 minutes, etc.

One or more other bed presence detection techniques can be performed, as described herein, to determine whether a bed-exit event is detected at the bed system 1900. As non-limiting examples, the computing system 1906 can process load cell signals to determine whether a change in load cell signals is indicative of the user 1902 leaving the bed system 1900. As another example, the computing system 1906 can process temperature sensor signals to determine whether a change in temperature signals is indicative of the user 1902 exiting the bed system 1900. The computing system 1906 can also process any combination of sensor signals to determine whether the user 1902 has exited the bed system 1900. In yet some implementations, the computing system 1906 can determine whether the user 1902's sleep session ended based on historic data about the user 1902 and/or alarms. For example, historic data can indicate that the user 1902 routinely exits the bed system 1900 at the same time every day or on particular days. Once the particular time occurs, the computing system 1906 can determine that a bed-exit event occurred. As another example, the user 1902 can set one or more alarms (by their mobile device and/or by a component of the bed system 1900) and once the alarm(s) goes off, the computing system 1906 can determine that a bed-exit event has occurred. Other variations are also possible.

Once the computing system 1906 detects the bed-exit event, the computing system 1906 can generate instructions to switch from operating in the active-operation mode to the low-power-saving mode (block D, 1926). As mentioned above and described herein, the computing system 1906 can generate instructions to switch the controller 1908 (or one or more other processors) from the active-operation mode to the low-power-saving mode so long as the bed system 1900 is empty in order to reduce overall power consumption and use of compute resources. Accordingly, the computing system 1906 can generate the instructions in block D (1926) to cause the processor of the controller 1908 (or multiple processors) to switch between the active-operation mode and the low-power-saving mode.

The computing system 1906 can execute the instructions in block E (1928). Sometimes, the computing system 1906 can execute the instructions a threshold amount of time after detecting the bed-exit event in block C (1924). Delaying execution of the instructions can advantageously ensure that the bed system 1900 is in fact empty and that the user 1902 has completed their current sleep session. Executing the instructions can include performing the instructions to cause the controller 1908 or a particular processor (e.g., a processor of the computing system 1906 and/or a processor of the controller 1908) to switch from the active-operation mode to the low-power-saving mode.

Optionally, for example, executing the instructions can cause the controller 1908 to suspend operations while in the low-power-saving mode (block F, 1930). As described herein, in the low-power-saving mode, one or more operations can be suspended. Suspending operations can include stopping the performance of certain processes. For example, the controller 1908 can stop performing processes that may require at least a threshold amount of processing power. The controller 1908 can stop performing processes such as detecting health and/or sleep metrics about the user 1902. As described herein, the controller 1908 can resume performing such processes once the computing system 1906 detects a bed-presence event at the bed system 1900.

Although the blocks A-F (1920-1930) are described in reference to switching from the active-operation mode to the low-power-saving mode (in relation to detecting bed-exit events), the blocks A-F may also be performed to switch from the low-power-saving mode to the active-operation mode (in relation to detecting bed-presence events).

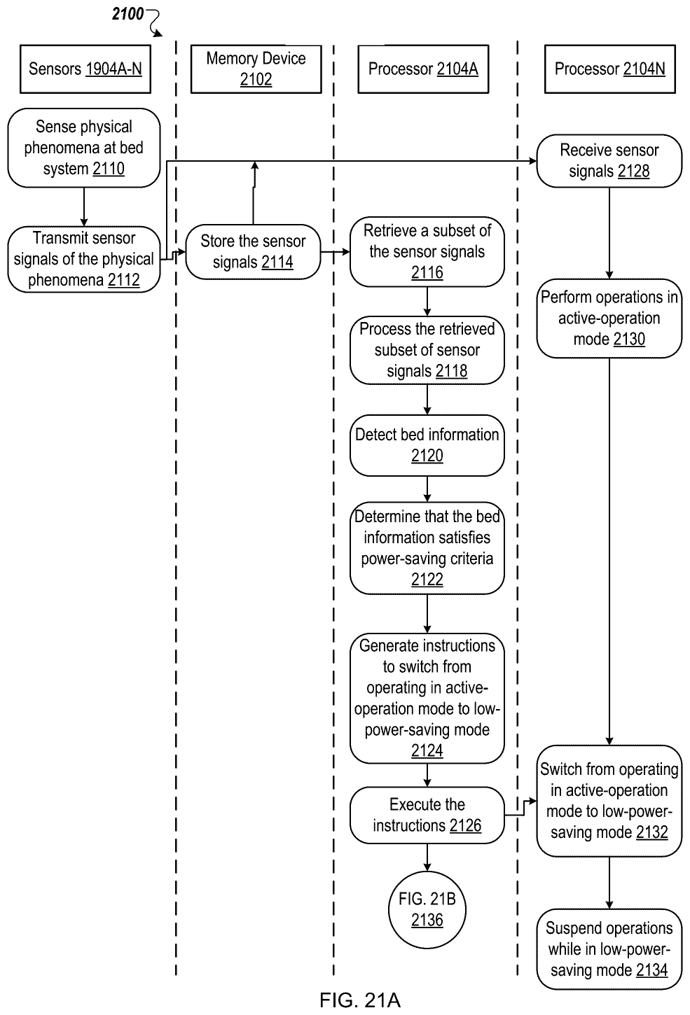

FIGS. 20A-B is a flowchart of a process 2000 for switching bed system components between active-operation mode (e.g., a normal operational state) and low-power-saving mode based on bed-exit event detection. The process 2000 can also be performed to switch the bed system components between low-power-saving mode and active-operation mode based on bed-presence event detection. The process 2000 can be performed by components described herein. For example, the process 2000 can be performed by a first processor. The process 2000 can be performed by the computing system 1906. The process 2000 can also be performed by one or more other computing systems described herein. For illustrative purposes, the process 2000 is described from the perspective of a computing system.

Referring to the process 2000 in both FIGS. 20A-B, the computing system can receive sensor signals generated by at least one sensor responsive to sensing physical phenomena at a bed system (block 2002). A memory of the computing system can be configured to store the sensor signals. Sometimes, the computing system can retrieve a subset of the sensor signals from the memory to then detect a bed-exit event based on processing the retrieved subset of the sensor signals.

The computing system can detect a bed-exit event at the bed system in block 2004. For example, the computing system can process the sensor signals in block 2006. The computing system can determine a change in pressure detected at the bed system that satisfies bed-exit criteria in block 2008. The computing system can determine a change in temperature detected at the bed system (e.g., at a microclimate of the bed system) that satisfies bed-exit criteria in block 2010. The computing system can determine that a current sleep session of a user at the bed system has ended in block 2012. In some implementations, the computing system can perform any one or more of the blocks 2006-2012. The computing system can also perform one or more other processes described herein to detect the bed-exit event at the bed system in block 2004.

Sometimes, in block 2004, the computing system can determine bed information at the bed system based on processing the sensor signals. The bed information can be a bed-exit or bed-presence event. Additionally or alternatively, the bed information can include biometrics of the user at the bed system. Then the computing system can determine whether the bed information satisfies power-saving criteria. The computing system can determine that the bed information satisfies the power-saving criteria based on (i) detecting the bed-exit event and optionally (ii) determining that a threshold amount of time passed since detecting the bed-exit event. During the threshold amount of time, a bed-entrance event may not be detected from processing the received sensor signals. The computing system can determine that the bed information does not satisfy the one or more power-saving criteria based on detecting the biometrics of the user for at least a threshold period of time. In other words, the user's heartrate, respiration rate, or other biometrics can be detected by processing the sensor signals, which therefore indicates that the user is currently on or resting in the bed system. If the bed information satisfies the one or more criteria, then the computing system can proceed to block 2014 described below. Sometimes, at a later time, the computing system can detect the biometrics of the user for at least the threshold period of time, then determine that the detected biometrics of the user satisfy power-activation criteria. In other words, the user's heartrate, respiration rate, body temperature, or other biometrics can be detected based on processing the sensor signals and then used to determine that the user has returned to the bed system and thus the processor(s) should operate in the active-operation mode in order to process and determine information about the user. If the power-activation criteria is satisfied, the computing system can accordingly generate instructions to cause the processor(s) to switch from operating in the low-power-saving mode to the active-operation mode.

The computing system can generate instructions to cause at least one processor to switch from operating in an active-operation mode to a low-power saving mode (block 2014). In the low-power-saving mode, the at least one processor can be suspended from performing operations. For example, the processor(s) can be suspended from processing sensor signals that are generated by the sensor(s) of the bed system. As another example, in the low-power-saving mode, the processor(s) can be suspended from transmitting the sensor signals and data generated responsive to processing the sensor signals to components of the bed system. In other words, the processor(s) can determine, based on the sensor signals that a temperature of a microclimate of the bed system is below a user-desired temperature level. However, when the processor(s) is put into the low-power-saving mode, the processor(s) may not transmit instructions to a heating unit of the bed system to activate and warm the microclimate to the user-desired temperature level. The processor(s) may transmit such instructions to the heating unit when the processor(s) is in the active operation mode. In some implementations, in the low-power-saving mode, the at least one processor may operate and therefore perform some operations while using less than a threshold amount of power. The processor(s) may perform only some operations or modified operations, such as transmitting the pressure signals to other components of the bed system at predetermined time intervals (e.g., every 30 minutes) rather than continuously in real-time or near real-time. As another example, the processor(s) may only process some sensor signals rather than all while in the low-power-saving mode.

In the active-operation mode, the at least one processor can perform operations while using more than a threshold amount of power. In other words, the processor(s) can perform operations that require significant amounts of processing power and/or compute resources. The operations can include processing the received sensor signals to determine health or sleep information about the user of the bed system, as an illustrative example. As another example, the operations may include executing at least one machine-learning trained model to determine health or sleep information about the user of the bed system.

As another example, in the active-operation mode, the processor(s) can retrieve the sensor signals from the memory of the computing system (or a shared memory) and then determine one or more health and/or sleep information about the user of the bed system based on processing the retrieved sensor signals. In some implementations, the processor(s) can receive the sensor signals directly from the sensors of the bed system while in the active-operation mode. In the active-operation mode, the processor(s) can determine the one or more health and/or sleep information about the user in real-time. Such information can also be determined in near real-time or in one or more other predetermined periods of time described herein.

The computing system can determine whether a threshold amount of time passes since detecting the bed-exit event in block 2016. The threshold amount of time can indicate that the user has left the bed system to end their current sleep session and that they are not returning to the bed system to resume their sleep session. If the threshold amount of time has not passed, the computing system can return to block 2002 and repeat blocks 2002-2016 until the threshold amount of time passes. If the threshold amount of time has passed, the computing system proceeds to block 2018. The threshold amount of time can be predetermined, based on the particular user and/or based on a generic population of users. Non-limiting examples of the threshold amount of time include, but are not limited to, 5 minutes, 10 minutes, 15 minutes, 20 minutes, 30 minutes, etc.

In block 2018, the computing system can execute the instructions to cause the processor(s) to operate in the low-power-saving mode. For example, the computing system can suspend current operations being executed by the processor(s) (block 2020). The computing system can also execute the instructions by transmitting a notification to the processor(s) that instructs the processor(s) to suspend current processing (and/or complete a current processing task and then suspend, stop, or otherwise pause other processing tasks that are queued for execution). As another example, the computing system can transmit less than a threshold amount of power to the processor(s) (block 2022). In other words, the computing system can instruct a power supply to transmit less than the threshold amount of power to the processor(s).

The computing system can continuously receive the sensor signals in block 2024. Block 2024 can be performed throughout the process 2000 described herein.

The computing system can then determine whether it detects a bed-entrance event at the bed system based on processing the sensor signals (block 2026). Block 2026 can be performed in real-time, near real-time, and/or at predetermined time intervals. (e.g., whenever the sensor signals are received in block 2024, once a threshold amount of sensor signals are received in block 2024, every 5 minutes, every 10 minutes, every 15 minutes, every 30 minutes).

To detect the bed-entrance event, the computing system can perform similar techniques as detecting the bed-exit event. As non-limiting examples, the computing system can detect a change in pressure based on received pressure signals. The change in pressure, which can be an increase in pressure from a prior pressure value at the bed system) can indicate that the user has entered the bed system. As another example, a change in temperature (such as an increase in temperature) of the microclimate at the bed system can indicate that the user has entered the bed system. Moreover, in some implementations, the computing system can also determine whether the change in pressure and/or the change in temperature exists for at least a threshold amount of time. The threshold amount of time can be 15 minutes, or any other threshold amount of time described herein. Therefore, if the computing system determines that the pressure and/or temperature increased at the bed system for at least the threshold amount of time, this can indicate that the user has entered the bed system to start a sleep session (rather than temporarily sitting on the bed to read or watch TV or placing something on the bed such as a pet or suitcase). Accordingly, the computing system can establish that a bed-entrance event was detected and that the processor(s) should be woken up to perform or resume operations in the active-operation mode.

If the computing system does not detect the bed-entrance event, the computing system returns to block 2024. The processor(s) can remain in the low-power-saving mode until the computing system detects the bed-entrance event (or some threshold amount of time before an expected bed-entrance event).

If the computing system detects the bed-entrance event, the computing system proceeds to block 2028, in which the computing system generates instructions to cause the processor(s) to switch from operating in the low-power-saving mode to the active-operation mode. For example, the computing system can perform or resume operations executed by the processor(s) (block 2030). The instructions can cause the processor(s) to resume operations that were being performed before the processor(s) was switched to operate in the low-power-saving mode. The instructions can also cause the processor(s) to perform any operations that may be performed when the processor(s) is operating at full capacity or otherwise receiving at least a threshold amount of power from a power supply. As another example, the computing system can process the sensor signals to determine health and/or sleep information about the user of the bed system (block 2032). The computing system can, as another example, apply at least one machine learning-trained model to the sensor signals to determine user information (block 2034). Blocks 2024-2034 can be performed at predetermined time intervals, in

some implementations. For example, the computing system can generate instructions that cause the processor(s) to (i) switch from operating in the low-power-saving mode to the active-operation mode, (ii) sync with a remote computing system, and/or (iii) switch from operating in the active-operation mode back to the low-power-saving mode. The predetermined time intervals can be every 30 minutes or other threshold periods of time, such as every 5 minutes, 10 minutes, 15 minutes, 20 minutes, 45 minutes, 60 minutes, etc. Accordingly, the computing system can iteratively generate and execute the instructions at the predetermined time intervals until a bed-entrance event is detected at the bed system. Sometimes, for example, the computing system may sync with a remote computing system only when in the active-operation mode in order to reduce power consumption and consumption of available compute and processing resources. Syncing with the remote computing system can include transferring sensor data to the remote computing system. The sensor data may be raw and/or unprocessed, which means transmitting this data can consume significant amounts of power and/or compute resources. Therefore, this data may only be transferred when the computing system syncs with the remote computing system.

Sometimes, the computing system can switch the processor(s) back and forth between the low-power-saving mode and the active-operation mode over the course of the predetermined time intervals. For example, the user may exit the bed system for more than the threshold amount of time, however the user may return to the bed system a couple of hours later, such as to take a nap. The computing system may generate instructions that cause the processor(s) to switch to the low-power-saving mode when the user exits the bed system, but then may instruct the processor(s) to switch back to the active-operation mode when the user returns to the bed system. Such a continuous process can beneficially result in short term and long term power savings.

As described herein, the processor(s) can be isolated from processors of the computing system. The processor(s) can utilize local memory when performing the techniques described herein. In some implementations, the processor(s) and the computing system can both access a shared memory. The computing system can access the shared memory on a more continuous basis than the processor(s) since the computing system may continuously check whether a bed-exit event is detected. The processor(s) on the other hand may access the shared memory only when the processor(s) is in the active-operation mode. Accordingly, while the processor(s) is operating in the low-power-saving mode, the computing system can remain in the active-operation mode to continuously receive the sensor signals and detect, based on processing the received sensor signals, a bed-entrance event at the bed system.

Once the processor(s) is switched to the active-operation mode, the computing system can return to block 2002 and repeat the process 2000. The process 2000 can be continuously performed using low-level hardware and minimal processing power so as to not consume large amounts of power. The process 2000 can be performed, as described herein, to switch the processor(s) or other bed system components to the low-power-saving mode in order to reduce overall power consumption and use of compute resources, thereby resulting in power savings, reduced carbon footprint, and allocation of available compute resources for other processes.

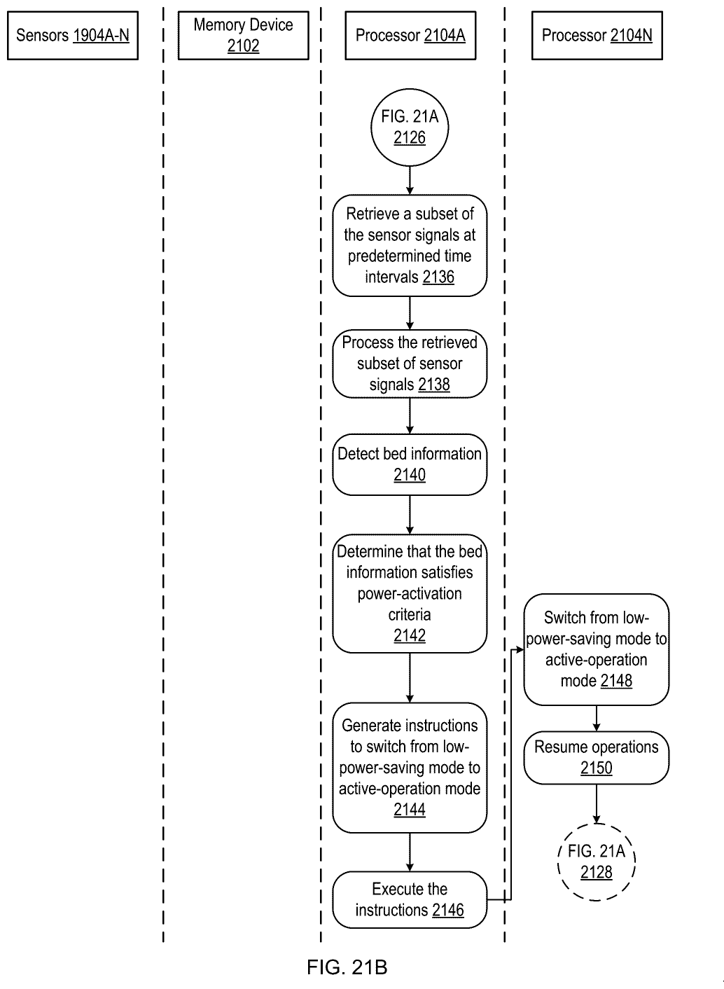

FIGS. 21A-B is a flowchart of a process 2100 for switching bed system components between active-operation mode and low-power-saving mode. The process 2100 can be performed by components described herein, including but not limited to the sensors 1904A-N, a memory device 2102, a processor 2104A (e.g., a first processor), and a processor 2104N (e.g., a second processor). One or more other components described herein are also possible.

In the illustrative example of the process 2100 in FIGS. 21A-B, the processor 2104A can be a low-level processor. As an illustrative, non-limiting example, the processor 2104A can be a Cortex-M7 256 kb TCM processor, which can be energy effective and efficient, isolated from other processors or computing components, and having local memory. In some implementations, the processor 2104A can be any other type of device and/or processor capable of receiving input (e.g., sensor signals), detecting a bed-exit or bed-presence event, and/or generating instructions that cause the processor 2104N to switch from active-operation mode to low-power-saving mode or vice-versa (e.g., wake-up signals, sleep signals). The processor 2104A can be part of the computer system 1906 described herein.

The processor 2104N can be part of the controller 1908 described herein. The processor 2104N can also be part of the computer system 1906. The processor 2104A can continuously operate (e.g., in the active-operation mode) to detect bed-exit and bed-entrance events at the bed system described herein. The processor 2104N can be configured to switch between the active-operation mode and the low-power-saving mode using the disclosed techniques. The processor 2104N can be, as a non-limiting illustrative example, a Cortext-AS3 core. The processor 2104N can be any other type of processor and/or device that can be used to perform complex processing (e.g., determinations of user health and/or sleep information in real-time or near real-time). In some implementations, the processors 2104A and 2104N can be part of the controller 1908 of the bed system. The controller 1908 can be a pump of the bed system.

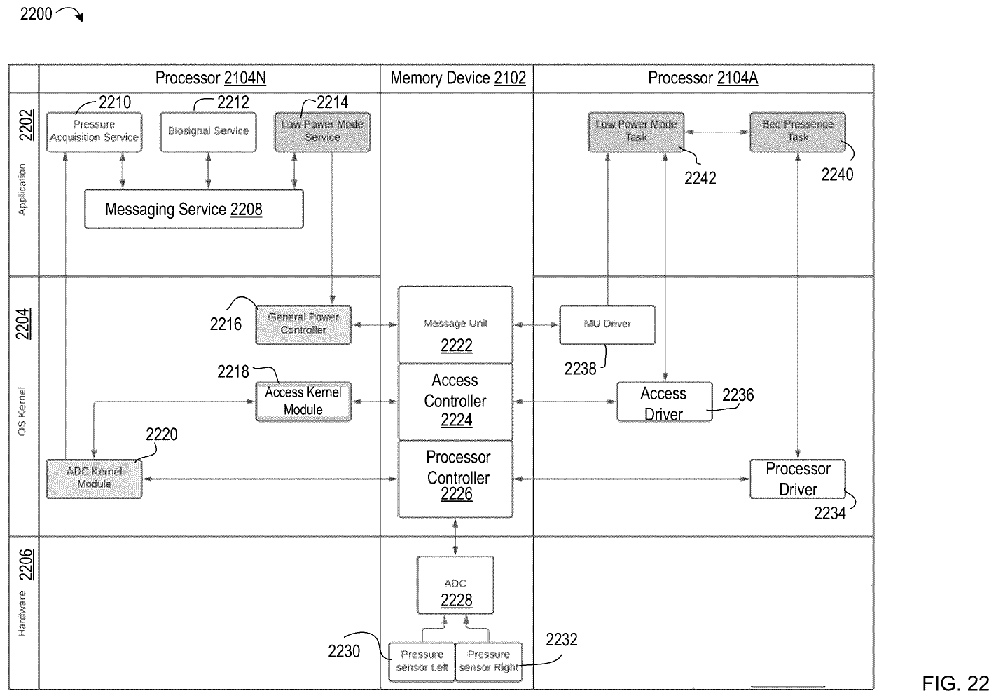

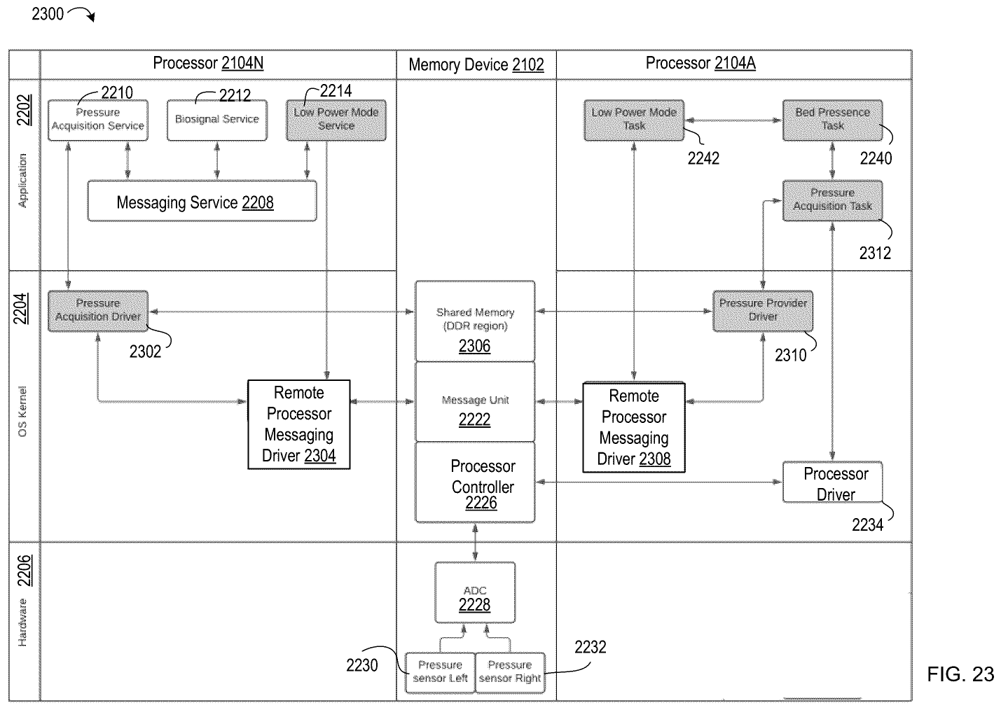

The memory device 2102 can also be separate from the processors 2104A and 2104N. In some implementations, the memory device 2102 and the processor 2104A can be part of the computer system 1906 and the processor 2104N can be separate. The memory device 2102 can be shared, or otherwise provide shared access to, by both the processors 2104A and 2104N. Various other implementations of the hardware described herein are also possible. Refer to FIGS. 22-23 for example system architectures that can be used to perform the disclosed techniques.

Referring to the process 2100 in both FIGS. 21A-B, the sensors 1904A-N can sense physical phenomena at the bed system (block 2110). The sensors 1904A-N can transmit sensor signals of the physical phenomena in block 2112 to the memory device 2102, the processor 2104A, and/or the processor 2104N.

The memory device 2102 can store the sensor signals in block 2114.

The processor 2104N can receive the sensor signals in block 2128 and then perform operations in the active-operation mode based on processing the sensors in block 2130. The processor 2104N can operate in the active-operation mode until the processor 2104A detects a bed-exit event (e.g., bed information that satisfies power saving criteria). While in the active-operation mode, the processor 2104N can utilize available compute resources, processing power, and power more generally to determine user health information, user sleep information, bed system adjustments, and other bed information. Sometimes, the processor 2104N can retrieve the sensor signals, or a subset of the sensor signals, from the memory device 2102 and then perform the operations using the retrieved sensor signals. The processor 2104N can receive (or retrieve) the sensor signals at any time (or at predetermined time intervals) while the processor 2104N is operating in the active-operation mode.

The processor 2104A can retrieve a subset of the sensor signals from the memory device 2102 in block 2116. The processor 2104A can retrieve the subset of the sensor signals that can be used to determine whether the user is currently in the bed system or has left the bed system. For example, the processor 2104A may retrieve pressure sensor signals that were just generated (or generated within a threshold amount of time, such as a past 5 minutes). Sometimes, the processor 2104A may also retrieve pressure sensor signals that were generated and previously assessed, such as pressure sensor signals during a last sleep session of the user or pressure sensor signals during the current sleep session of the user but that were generated more than the threshold amount of time before the recently generated sensor signals (e.g., 30 minutes ago, 1 hour ago, 2 hours ago). Therefore, as part of determining whether the user is in the bed system, the processor 2104A may compare the recently generated sensor signals with the previously generated and assessed pressure signals. The processor 2104A can also retrieve other sensor signals as described herein that may be used to detect bed-exit and/or bed-presence events. In some implementations, the processor 2104A may receive the sensor signals directly from the sensors 1904A-N.

The processor 2104A can continuously retrieve the subset of the sensor signals, such as in real-time or near real-time as the sensor signals are generated by the sensors 1904A-N and transmitted to the memory device 2102 for storage. Sometimes, the processor 2104A can retrieve the subset of the sensor signals at predetermined time intervals. The predetermined time intervals can include, but are not limited to, every hour, 30 minutes, 20 minutes, 15 minutes, 10 minutes, 5 minutes, 1 minute, etc. Retrieving and processing the subset of the sensor signals at the predetermined time intervals can advantageously provide for increased savings in both short term and long term power consumption. Retrieving and processing the subset of the sensor signals at the predetermined time intervals can also advantageously allow for available compute resources and processing power to be allocated to operations/processes requiring more resources, such as operations performed by the processor 2104N to determine real-time or near real-time health information about the user, sleep information about the user, and/or bed system adjustments. The bed system components may therefore more efficiently utilize available resources to provide accurate and real-time or near real-time information to the user of the bed system to improve their overall sleep experience.

The processor 2104A can process the retrieved subset of sensor signals in block 2118. The processor 2104A can detect bed information based on processing the subset of the sensor signals (block 2120). The processor 2104A can implement a lightweight and simple process/algorithm to process the sensor signals and detect the bed information. As a result, the processor 2104A can be low-level hardware and/or use minimal compute and/or processing power resources, even though the processor 2104A may continuously remain in the active-operation mode. As described above, the processor 2104A can provide the subset of sensor signals as input to a machine learning model that was trained to detect bed-presence and/or bed-exit events (e.g., the bed information) based on changes in the subset of sensor signals (e.g., changes in pressure sensor signals). The processor 2104A can also apply one or more rules or algorithms to detect bed information.

The processor 2104A can also determine whether the bed information satisfies power-saving criteria in block 2122. For example, the processor 2104A can determine whether the bed information indicates that the user has exited the bed system for at least a threshold amount of time. The bed information can include a change in pressure indicating that the user has gotten up from the bed system, but shortly thereafter (e.g., 5 minutes after, 1 minute after) another change in pressure indicates that the user returned to the bed system. The user may have gotten out of bed momentarily to get a glass of water or use the bathroom. Therefore, the user has not exited the bed system for at least the threshold amount of time (e.g., 15 minutes, 30 minutes, 1 hour), which would indicate that the user has likely ended their sleep session and will not be returning to the bed system until their next sleep session (e.g., the day has begun and the user will return to the bed system that evening when they are ready to go to sleep). On the other hand, if the change in pressure indicates that the user exited the bed for at least the threshold amount of time, the processor 2104A can determine that the bed-exit event was detected (e.g., the bed information) and that the power-saving criteria has been satisfied.

As another non-limiting example, the processor 2104A can receive timing and/or alarm information from components of the bed system, such as a time at which a wakeup alarm goes off or is scheduled to go off for the user (e.g., the bed information). The user can exit the bed system as a result of their wakeup alarm going off, thereby indicating that the user's current sleep session has ended and that the power-saving criteria has been satisfied.

Sometimes, the bed system can be occupied by two users. The processor 2104A can therefore determine whether each user is present on the bed system. If a user on a right side of the bed system exits the bed and a user on the left side of the bed system remains in the bed system, then the processor 2104A may determine that the power-saving criteria has not been met. Since the processor 2104N may still determine user health and/or sleep information for the user on the left side of the bed system, the processor 2104A can determine that the bed system is not yet empty and therefore the processor 2104N should remain operating in the active-operation mode. When the bed system is occupied by two users, the processor 2104A may therefore determine that the processor 2104N should be switched to the low-power-saving mode once both users exit the bed system for at least the threshold amount of time. In some implementations, one processor can be configured to determine user sleep and/or health information for the left side of the bed and another processor can be configured to determine user sleep and/or health information for the right side of the bed. In such implementations, the processor 2104A can determine that the power-saving criteria is satisfied for a side of the bed system where the user has exited for at least the threshold amount of time and thus instruct the processor associated with only that side of the bed to switch to the low-power-saving mode.

Based on determining that the bed information satisfies the power-saving criteria, the processor 2104A can generate instructions to switch from operating in the active-operation mode to the low-power-saving mode (block 2124). The instructions can cause the processor 2104N to switch between the modes. The instructions may cause one or more other bed system components to switch between the modes. For example, the instructions can cause a power supply of the bed system (not depicted) to stop providing power to the processor 2104N or another component of the bed system. As another example, the instructions can cause the power supply to reduce an amount of power provided to the processor 2104N or the other component of the bed system, where the reduced amount of power provides for lowering short term and long term power consumption of the bed system components.

Accordingly, the processor 2104A can execute the instructions in block 2126, which can cause the processor 2104N to switch from operating in the active-operation mode to the low-power-saving mode (block 2132). In the low-power-saving mode, for example, cores of the processor 2104N can be put into a deep sleep state while cores of the processor 2104A remain active to monitor the sensor signals (e.g., pressure sensor signals), detect bed-entrance or bed presence events, and accordingly wake up the cores of the processor 2104N. After all, while the user is not in the bed system (e.g., the user is not sleeping), power is underutilized, hardcore processing and/or transmission of sensor data or other data may not be required, and so power savings can be achieved by reducing the processor 2104N to the low-power-saving mode (e.g., a sleep state).

If the processor 2104N was performing operations (block 2130) at a time that the instructions are executed (block 2126), the processor 2104N may suspend or otherwise stop performing those operations (block 2134). As another example, the processor 2104N may complete a current process being performed and then suspend other operations from being performed thereafter. As yet another example, the processor 2104N may continue performing the operations but at a slower rate by consuming less power and/or compute resources. The processor 2104N can suspend performing the operations until a bed-entrance event is detected at the bed system by the processor 2104A (e.g., bed information satisfies power-activation criteria).

Once the processor 2104A executes the instructions (block 2126), the processor 2104A can continue to retrieve subsets of sensor signals at predetermined time intervals from the memory device 2102 (block 2136). In some implementations, the processor 2104A can receive the sensor signals directly from the sensors 1904A-N at the predetermined time intervals. The predetermined time intervals can include, but are not limited to, every 5 minutes, 10 minutes, 15 minutes, 20 minutes, 30 minutes, etc.

In yet some implementations, the processor 2104A can wake up the processor 2104N at predetermined time intervals (e.g., every 30 minutes, every hour) in order to integrate and/or sync the processor 2104N with the processor 2104A, the computing system 1906, a remote computing system, and/or a cloud-based computing system. The remote computing system and/or the cloud-based computing system can be configured to perform one or more operations associated with determining user sleep and/or health information at the bed system 1900, as described throughout this disclosure.

Whenever the processor 2104A retrieves or receives the sensor signals, the processor 2104A can process the signals (block 2138). The signals can be processed as described herein to detect bed information (block 2140). The processor 2104A can determine whether the bed information satisfies power-activation criteria (block 2142). For example, the processor 2104A can determine whether the bed information is indicative of a bed-entrance event. If the bed information is not indicative of the bed-entrance event, the processor 2104A can continue to perform blocks 2136-2142 until the bed-entrance event is detected (e.g., continue to perform blocks 2136-2142 at predetermined time intervals such as every 15 minutes, 30 minutes, etc.). If the bed information is indicative of the bed-entrance event, the power-activation criteria is satisfied in block 2142, and the processor 2104A proceeds to block 2144.

In block 2144, the processor 2104A generates instructions to switch from the low-power-saving mode to the active-operation mode. The processor 2104A then executes the instructions (block 2146). Executing the instructions can cause the processor 2104N to switch from the low-power-saving mode to the active-operation mode (block 2148). As another non-limiting example, executing the instructions may include instructing a power supply (not depicted) to provide at least a threshold amount of power to the processor 2104N (e.g., resume providing the amount of power that was provided to the processor 2104N before the processor 2104N was initially switched to the low-power-saving mode).

Once the processor 2104N switches to the active-operation mode, the processor 2104N resumes operations in block 2150. Sometimes, the processor 2104N can resume operations that it had begun and suspended in block 2134. Sometimes, the processor 2104N can resume operations that had not yet begun in block 2134 but were queued to be performed before the processor 2104N switched to the low-power-saving mode. Sometimes, the processor 2104N can perform new operations that have been queued while the processor 2104N was in the low-power-saving mode and/or immediately after or some threshold amount of time after the processor 2104N is switched back to the active-operation mode.

Optionally, the processor 2104N can return to block 2128 and perform operations (block 2130) based on received or retrieved sensor signals (block 2128) so long as the processor 2104N remains in the active-operation mode and the processor 2104A does not determine that the processor 2104N should switch back to the low-power-saving mode (block 2124). As described herein, the process 2100 can be continuously performed.

FIG. 22 is an example system architecture 2200 for switching bed system components between active-operation mode and low-power-saving mode. The system architecture 2200 can be used for any bed system described herein. Sometimes, the bed system can have an existing system architecture and one or more components of the system architecture 2200 can be added to the bed system's existing system architecture. As another example, the bed system's existing system architecture can be replaced by the example system architecture 2200.

The example system architecture 2200 of FIG. 22 can include the processors 2104A and 2104N and the memory device 2102 (refer to FIGS. 21A-B). As described herein, the processor 2104N can be configured to perform logic and processing of data to determine user health and/or sleep information. The processor 2104A can be configured to provide lightweight real-time processing of some sensor data to determine bed presence events and whether to put the processor 2104N in low-power-saving mode or active-operation mode. The memory device 2102 can be separate from the processors 2104A and 2104N. In some implementations, for example, the memory device 2102 can be part of a remote computing system and/or network of computing devices.

Applications 2202 (e.g., services, software) of the processor 2104N can include a pressure acquisition service 2210, a biosignal service 2212, a low power mode service 2214, and/or a messaging service 2208. An operating system (OS) kernel 2204 of the processor 2104N can include a general power controller 2216, an access kernel module 2218, and/or an analog-to-digital converter (ADC) kernel module 2220. The memory device 2102 can include a message unit 2222, an access controller 2224, and/or a processor controller 2226. Hardware 2206 of the memory device 2102 may include an ADC 2228, a left pressure sensor 2230, and/or a right pressure sensor 2232. The applications 2202 of the processor 2104A can include a low power mode task service 2242 and/or a bed presence task service 2240. The OS kernel 2204 of the processor 2104A can include a messaging unit (MU) driver 2238, an access driver 2236, and/or a processor driver 2234.

During runtime operation, pressure data can be collected by the left and/or right pressure sensors 2230 and 2232, respectively. The left pressure sensor 2230 can be configured to detect/collect pressure data on a left side of the bed system. The right pressure sensor 2232 can be configured to detect/collect pressure data on a right side of the bed system. In some implementations, the bed system may include only one of the left and right pressure sensors 2230 and 2232. In some implementations, the bed system may include multiple pressure sensors on one or both sides of the bed system. The collected pressure data can pass through the ADC 2228 such that they can be processed/converted into a readable format for the processors 2104A and 2104N. The processors pressure data can then be stored in the memory device 2102 and accessed by both the processors 2104A and 2104N.

The processor controller 2226 of the memory device 2102 can provide communication with each of the processors 2104A and 2104N. For example, the processor controller 2226 can provide communication with the ADC kernel module 2220 of the OS kernel 2204 of the processor 2104N.

As another example, the processor controller 2226 of the memory device 2102 can establish a communication with the processor driver 2234 of the processor 2104A so that the processed pressure data can be retrieved, by the processor driver 2234 from the memory device 2102 and provided to the bed presence task service 2240 of the processor 2104A. The bed presence task service 2240 can perform the techniques described herein of processing the pressure data to detect a bed-exit event and/or a bed-presence event. A determination made by the bed presence task service 2240 can be provided to the low power mode task service 2242 of the processor 2104A. The service 2242 can, for example, determine whether the bed-exit event exists for at least a threshold amount of time. The service 2242 can also generate instructions that cause the processor 2104N to switch from the active-operation mode to the low-power-saving mode, as described herein.

The access driver 2236 of the processor 2104A can provide communication between the low power mode task service 2242 and the access controller 2224 of the memory device 2102. The access controller 2224 can also provide communication between the memory device 2102 and the ADC kernel module 2220 via the access kernel module 2218.

The ADC kernel module 2220 of the processor 2104N can communicate with the pressure acquisition service 2210 of the processor 2104N. The service 2210 can, for example, retrieve the pressure data from the memory device 2102 via the communication established by the ADC kernel module 2220 with the access controller 2224 and/or the processor controller 2226. The service 2210 can also receive the pressure data via the messaging service 2208, which can provide communication of data amongst bed system components. In some implementations, the service 2210 can be configured to process the received pressure data to determine health and/or sleep information/metrics about the user(s) of the bed system. The service 2210 can process the received pressure data while operating in the active-operation mode.

Similarly, the biosignal service 2212 can receive sensed data and/or stored data (e.g., historic data) about the user(s) of the bed system via the messaging service 2208, then process that data to determine biometric information about the user(s). The biosignal service 2212 can perform such techniques while the processor 2104 operates in the active-operation mode. The processor 2104N can include one or more additional, other, or fewer services as applications 2202.

The low power mode service 2214 of the processor 2104N can be configured to suspend operations of the applications 2202, such as the services 2210 and/or 2212. For example, when the low power mode task service 2242 determines that the bed system is empty and that the processor 2104N should switch to the low-power-saving mode, the service 2242 can generate a message/notification with instructions to suspend operations at the processor 2104N. This message can be transmitted, via the MU driver 2238 and the message unit 2222 to the general power controller 2216 of the processor 2104N. This message can also be received by the service 2214 via the messaging service 2208. The service 2214 can then instruct the services 2210 and/or 2212 to suspend performing their respective operations. Such instructions can be transmitted via the messaging service 2208. The low power mode service 2214 can also communicate with the general power controller 2216 to indicate that the operations are being suspended by the applications 2202 of the processor 2104N.

The general power controller 2216 can adjust an amount of power that is provided to components of the processor 2104N based upon a determination by the low power mode task service 2242 that the processor 2104N should switch to the low-power-saving mode. Thus, the general power controller 2216 can be configured to adjust how much power (or other resources, such as compute or processing resources) is provided to one or more components of the processor 2104N based on messages communicated by the low power mode task service 2242 and/or the low power mode service 2214.

Although the system architecture 2200 of FIG. 22 is described from the perspective of switching components of the processor 2104N from the active-operation mode to the low-power-saving mode, the system architecture 2200 may also be used to switch the components of the processor 2104N from the low-power-saving mode to the active-operation mode. As an illustrative example, the bed presence task service 2240 can receive the pressure data from the memory device 2102 and detect a bed-entrance event. A notification indicating the bed-entrance event can be transmitted to the low power mode task service 2242, which can then communicate with the general power controller 2216 (via the message unit 2222) and/or the low power mode service 2214 (via the messaging service 2208) with instructions to cause the processor 2104N to switch from the low-power-saving mode to the active-operation mode. Once the low power mode service 2214 receives the instructions, instructions can then be transmitted to the services 2210 and/or 2212 via the messaging service 2208 to resume performing operations. As another example, the general power controller 2216 can resume providing at least a threshold amount of power to the processor 2104N so that the services 2210 and/or 2212 can resume performing their respective operations.

In some implementations, the pressure acquisition service 2210, the biosignal service 2212, the messaging service 2208, the messaging unit 2222, the access controller 2224, the processor 2226, the ADC 2228, the left and right pressure sensors 2230 and 2232, the MU driver 2238, the access driver 2236, and/or the processor driver 2234 may already exist in the bed system(s) described throughout this disclosure. The general power controller 2216 and the ADC kernel model 2220 may also exist in the bed system but can be modified to achieve the disclosed techniques. The low power mode service 2214, the access kernel module 2218, the low power mode task service 2242, and the bed presence task service 2240 can be new components added to the existing bed systems. The disclosed techniques may therefore be easily integrated into existing bed systems with minimal modification or addition of components. Implementing the disclosed techniques may be less expensive/costly because few components may be modified or added to the existing bed system architectures, thereby making adoption of the disclosed techniques efficient and easy.

FIG. 23 is another example system architecture 2300 for switching bed system components between active-operation mode and low-power-saving mode. The system architecture 2300 can be used for any bed system described herein. Sometimes, the bed system can have an existing system architecture and one or more components of the system architecture 2300 can be added to the bed system's existing system architecture. As another example, the bed system's existing system architecture can be replaced by the example system architecture 2300.

The system architecture 2300 is similar to the system architecture 22 of FIG. 22. For example, the system architecture 2300 includes the processors 2104A and 2104N and the memory device 2102. The applications 2202 of the processor 2104N include the pressure acquisition service 2210, the biosignal service 2212, the low power mode service 2214, and the messaging service 2208. The memory device 2102 includes the message unite 2222 and the processor controller 2226 as part of the OS kernel 2204 and the ADC 2228 and the left and right pressure sensors 2230 and 2232 as part of the hardware 2206. The processor 2104A includes, as the applications 2202, the low power mode task service 2242 and the bed presence task service 2240 and, as part of the OS kernel 2204, the processor driver 2234.

Unlike the system architecture 2200 in FIG. 22, the system architecture 2300 in FIG. 23 includes some additional or different components. In some implementations, the system architecture 2200 in FIG. 22 can have minimum modifications to the OS kernel 2204 of the processors 2104A and 2104N, which can result in less synchronization between the processors. The system architecture 2300 in FIG. 23, on the other hand, may require additional modifications to the OS kernel 2204 of the processors 2104A and 2104N. The system architecture 2300 may be faster to implement than the system architecture 2200, even though the system architecture 2300 can require additional modifications and/or new kernel development.

Unlike the system architecture 2200 in FIG. 22, the system architecture 2300 in FIG. 23 can include one or more of the following additional or different components: the OS kernel 2204 of the processor 2104N can include a pressure acquisition driver 2302 and/or a remote processor messaging driver 2304, the drivers 2302 and 2304 can provide for access of the applications 2202 of the processor 2104N to pre-processed data that is stored in the shared memory 2306, the memory device 2102 can include a shared memory 2306 (e.g., DDR region), the applications 2202 of the processor 2104A can include a pressure acquisition tasks service 2312, and the OS kernel 2204 of the processor 2104A can include a remote processor messaging driver 2308 and a pressure provider driver 2310. In the example system architecture 2300, pressure acquisition services can be performed by the low-level processor 2104A rather than the processor 2104N, which is done in the system architecture 2200 of FIG. 22. The system architecture 2300 can provide for simpler synchronization of components, such as simpler synchronization of the processor 2104N when its cores are in active and/or sleep states, in comparison to the system architecture 2200 of FIG. 22 or other possible system architectures that may be implemented with the disclosed technology.

During runtime operation, the pressure data from the pressure sensors 2230 and 2232 can be stored in the shared memory 2306 of the memory device 2102. The pressure provider driver 2310 of the processor 2104A can receive or retrieve the pressure data from the shared memory 2306 and provide the pressure data to the pressure acquisition task service 2312. In some implementations, the service 2312 can request the pressure data (e.g., at predetermined time intervals) and then the driver 2310 can retrieve the pressure data from the shared memory 2306 and transmit the pressure data to the service 2312. The service 2312 can process the pressure data and/or transmit the pressure data to the bed presence task service 2240. The service 2240 can detect a bed-exit event, as described in reference to FIG. 22. A message about the detected event is transmitted to the low power mode task service 2242, which can communicate via the remote processor messaging driver 2308 to the message unit 2222 of the memory device 2102 and the low power mode service 2214 of the processor 2104N. The message can therefore be communicated to the service 2214 to suspend operations of the services 2210 and 2212 (e.g., to switch the processor 2104N to low-power-saving mode).

Moreover, the pressure acquisition driver 2302 of the processor 2104N can communicate with the shared memory 2306 and/or the message unit 2222 (e.g., via the remote processor messaging driver 2304). The driver 2302 can sometimes receive a request for pressure data from the pressure acquisition service 2210, then retrieve the pressure data from the shared memory 2306 based on the request. As another example, the driver 2302 can communicate with the pressure acquisition task service 2312 and/or the bed presence task service 2240 of the processor 2104A (via the remote processor messaging driver 2304 and the message unit 2222) to receive the pressure data and provide the pressure data to the pressure acquisition service 2210 for further processing.

In some implementations, the components 2210, 2212, 2208, 2306, 2222, 2226, 2228, 2230, 2232, 2234, and 2308 may already exist in bed system architectures. The remote processor messaging driver 2304 may also already exist in the bed system architectures but can be modified to achieve the disclosed techniques. The components 2214, 2302, 2242, 2240, 2312, and/or 2310 can then be added to the existing bed system architectures as new components. As described in reference to FIG. 22, since minimal, low-cost modifications and/or additions can required to the existing bed system architectures, implementing the disclosed techniques can be simple, easy, and efficient.

Refer to FIG. 22 for additional discussion about some of the components described in FIG. 23.

In some implementations, the disclosed techniques can be sent out as an update to existing bed systems. As a result, modifications may not be required to system architectures of the existing bed systems. In some implementations, the disclosed techniques can be implemented and thus integrated into new bed systems. In yet some implementations, bed presence techniques and algorithms may already be performed at the bed systems and thus leveraged with the disclosed techniques without making substantial changes or modifications to the existing bed systems.

What is claimed is:

1. A bed system comprising:
at least one sensor configured to sense physical phenomena at the bed system;
a controller having processors and memory, wherein the controller is in communication with the at least one sensor, wherein at least one processor of the processors operates in an active-operation mode, wherein the controller is configured to:
receive, from the at least one sensor, sensor signals generated by the at least one sensor responsive to sensing the physical phenomena at the bed system;
detect, based on processing the received sensor signals, a bed-exit event at the bed system;
generate, based on the detected bed-exit event, instructions to cause the at least one processor to switch from operating in the active-operation mode to a low-power-saving mode; and
execute the instructions to cause the at least one processor to operate in the low-power-saving mode.

2. The bed system of claim 1, wherein the controller is further configured to:
continuously receive, from the at least one sensor, the sensor signals;
detect, based on processing the received sensor signals, a bed-entrance event at the bed system; and
generate, based on the detected bed-entrance event, instructions to cause the at least one processor to switch from operating in the low-power-saving mode to the active-operation mode.

3. The bed system of claim 2, wherein the instructions cause the at least one processor to resume operations being performed before the at least one processor was switched to operate in the low-power-saving mode.

4. The bed system of claim 1, wherein the controller is further configured to execute the instructions based on determining that a threshold amount of time passed since the bed-exit event was detected.

5. The bed system of claim 1, wherein executing the instructions causes the at least one processor to suspend current operations being executed, by the at least one processor.

6. The bed system of claim 1, wherein, in the low-power-saving mode, the at least one processor is suspended from performing operations.

7. The bed system of claim 6, wherein, in the low-power-saving mode, the at least one processor is suspended from processing sensor signals that are generated by the at least one sensor.

8. The bed system of claim 6, wherein, in the low-power-saving mode, the at least one processor is suspended from transmitting the sensor signals and data generated responsive to processing the sensor signals to components of the bed system.

9. The bed system of claim 1, wherein, in the low-power-saving mode, the at least one processor operates while using less than a threshold amount of power.

10. The bed system of claim 1, wherein, in the active-operation mode, the at least one processor performs operations while using more than a threshold amount of power.

11. The bed system of claim 10, wherein the operations include processing the received sensor signals to determine health or sleep information about a user of the bed system.

12. The bed system of claim 10, wherein the operations include executing at least one machine-learning trained model to determine health or sleep information about a user of the bed system.

13. The bed system of claim 1, wherein the at least one sensor is a pressure sensor.

14. The bed system of claim 1, wherein detecting the bed-exit event comprises:
determining, based on the received sensor signals, a change in pressure detected at the bed system; and
determining that the change in pressure satisfies bed-exit criteria.

15. The bed system of claim 1, wherein detecting the bed-exit event comprises:
determining, based on the received sensor signals, a change in temperature at a microclimate of the bed system; and
determining that the change in temperature satisfies bed-exit criteria.

16. The bed system of claim 1, wherein detecting the bed-exit event comprises determining that a current sleep session of a user of the bed system has ended.

17. The bed system of claim 1, wherein executing the instructions comprises transmitting a notification to the at least one processor instructing the at least one processor to suspend current processing.

18. The bed system of claim 1, wherein the controller is further configured to generate and execute instructions at predetermined time intervals that cause the at least one processor to (i) switch from operating in the low-power-saving mode to the active-operation mode, (ii) sync with a remote computing system, and (iii) switch from operating in the active-operation mode back to the low-power-saving mode.

19. The bed system of claim 18, wherein the predetermined time intervals are every 30 minutes.

20. The bed system of claim 18, wherein the controller is configured to iteratively generate and execute the instructions at the predetermined time intervals until a bed-entrance event is detected at the bed system.
